(19) United States
(12) Patent Application Publication
(10) Pub. No.: US 2026/0318870 A1
(43) Pub. Date: Oct. 15, 2026

(54) SYSTEMS AND METHODS FOR FIELD ASYMMETRIC ION MOBILITY SEPARATION IN REDUCED PRESSURE

(71) Applicant: Peninsula Technologies, LLC, Wilmington, DE (US)

(72) Inventors: Satendra PRASAD, Belmont, CA (US); Mihajlo DZEPINA, Toronto (CA); Viatcheslav V. KOVTOUN, Boise, ID (US)

(21) Appl. No.: 19/379,542

(22) Filed: Nov. 4, 2025

Related U.S. Application Data
(63) Continuation of application No. PCT/US2024/027512, filed on May 2, 2024.
(60) Provisional application No. 63/500,177, filed on May 4, 2023.

(51) Int. Cl. G01N 27/624

(52) U.S. Cl. CPC G01N 27/624

(57) ABSTRACT

Described herein are coaxial reduced-pressure field asymmetric ion mobility separation devices and methods of using said devices to separate singly charged species from multiply charged species.

### CROSS-REFERENCE

This application is continuation of International Application No. PCT/US2024/027512, filed May 2, 2024, which claims the benefit of U.S. Provisional Application No. 63/500,177, filed May 4, 2023, which is incorporated herein by reference in its entirety.

### BACKGROUND

Chemical noise caused by background ions remains a significant limitation to sensitivity and limits of detection in mass spectrometry and ion mobility spectrometry, particularly in proteomics where many singly charged interferences can obscure signals from multiply charged analyte ions. Accordingly, improved methods and devices for reducing and/or eliminating chemical noise are needed.

### SUMMARY

Provided herein are reduced-pressure field asymmetric ion mobility devices and methods of use.

Provided herein are reduced-pressure field asymmetric ion mobility device comprising: an enclosed mobility chamber having an ion inlet and an ion outlet disposed at opposite ends and configured to be filled with an inert gas at a pressure of less than atmospheric pressure; at least one inner electrode disposed longitudinally between the ion inlet and the ion outlet of the enclosed mobility chamber; at least one outer electrode disposed longitudinally between the ion inlet and the ion outlet of the enclosed mobility chamber, the outer electrode being disposed such that the inner electrode is at least partially enclosed within the outer electrode; and one or more power supplies configured deliver a waveform to the inner electrode or the outer electrode, the waveform being configured to differentially deflect ions having different ion mobilities based on interaction of the ions with the waveform and the inert gas, wherein the differential deflection is configured to selectively remove ions having mobilities that correspond to singly charged species prior to said species reaching the ion outlet.

Provided herein are methods of separating singly charged ions from multiply charged ions, the method comprising: (a) providing an ion flux to an ion inlet of a reduced-pressure field asymmetric ion mobility device, the reduced-pressure field asymmetric ion mobility device comprising: an enclosed mobility chamber having the ion inlet and an ion outlet disposed at opposite ends and configured to be filled with an inert gas at a pressure of less than atmospheric pressure; at least one inner electrode disposed longitudinally between the ion inlet and the ion outlet of the enclosed mobility chamber; at least one outer electrode disposed longitudinally between the ion inlet and the ion outlet of the enclosed mobility chamber, the outer electrode being disposed such that the inner electrode is at least partially enclosed within the outer electrode; and one or more power supplies configured deliver a waveform to the inner electrode or the outer electrode, the waveform being configured to differentially deflect ions having different ion mobilities based on interaction of the ions with the waveform and the inert gas, wherein the differential deflection is configured to selectively remove ions having mobilities that correspond to singly charged species prior to said species reaching the ion outlet; (b) applying the waveform using the one or more power supplies to thereby substantially prevent ions of the ion flux having mobilities that correspond to singly charged species from reaching the ion outlet of the reduced-pressure field asymmetric ion mobility device; and (c) obtaining a multiply charged ion population at the ion outlet of the reduced-pressure field asymmetric ion mobility device which is enriched for ions that correspond to multiply charged species. Further provided herein are methods or reduced-pressure field asymmetric ion mobility devices wherein the pressure of the gas is less than about 700 torr (e.g., less than about 100 torr, less than about 10 torr, or less than about 5 torr). Further provided herein are methods or reduced-pressure field asymmetric ion mobility devices wherein a distance between the ion inlet and the ion outlet is about 10 mm to about 700 mm (e.g., about 100 mm to about 500 mm., about 200 mm to about 400 mm, or about 250 mm to about 350 mm). Further provided herein are methods or reduced-pressure field asymmetric ion mobility devices wherein a distance from a central axis of the enclosed mobility chamber to an outer surface of the at least one outer electrode is about 7 mm to about 50 mm (e.g., about 10 mm to about 40 mm, or about 15 mm to about 25 mm). Further provided herein are methods or reduced-pressure field asymmetric ion mobility devices wherein a distance from a central axis of the enclosed mobility chamber to an outer surface of the at least one inner electrode is about 0.2 mm to about 20 mm (e.g., about 1 mm to about 15 mm, or about 3 mm to about 10 mm). Further provided herein are methods or reduced-pressure field asymmetric ion mobility devices wherein a distance from an outer surface of the at least one inner electrode to an inner surface of the at least one outer electrode is about 5 mm to about 40 mm (e.g., about 5 mm to about 30 mm, about 8 mm to about 20 mm, or about 10 mm to about 15 mm). Further provided herein are methods or reduced-pressure field asymmetric ion mobility devices wherein the one or more power supplies provide a waveform comprising a sinusoidal waveform, a square waveform, a triangular waveform, a sawtooth waveform, or combinations of one or more thereof. Further provided herein are methods or reduced-pressure field asymmetric ion mobility devices wherein the one or more power supplies provide a waveform comprising at least two sinusoids which are phase-shifted with respect to each other. Further provided herein are methods or reduced-pressure field asymmetric ion mobility devices wherein the phase shift is about 30° to about 120° (e.g., about 30°, about 45°, about 60°, about 90°, or about 120°). Further provided herein are methods or reduced-pressure field asymmetric ion mobility devices wherein the outer electrode comprises at least one ion outlet. Further provided herein are methods or reduced-pressure field asymmetric ion mobility devices wherein the ion outlet comprises an opening in the outer electrode. Further provided herein are methods or reduced-pressure field asymmetric ion mobility devices wherein the opening comprises the shape of a slit, half-moon, circle, or cross. Further provided herein are methods or reduced-pressure field asymmetric ion mobility devices wherein the slit extends at an angle (e.g., about 90°) with the longitudinal axis of the outer electrode. Further provided herein are methods or reduced-pressure field asymmetric ion mobility devices wherein the slit extends at least about 15%, at least about 30%, at least about 45%, or at least about 50% around the circumference of the outer electrode.

Further provided herein are methods or reduced-pressure field asymmetric ion mobility devices wherein the at least one outlet is operably coupled to at least one ion optic. Further provided herein are methods or reduced-pressure field asymmetric ion mobility devices wherein the outer electrode comprises at least two ion outlets. Further provided herein are methods or reduced-pressure field asymmetric ion mobility devices wherein the at least two ion outlets are operably coupled to a common ion optic. Further provided herein are methods or reduced-pressure field asymmetric ion mobility devices wherein the at least two ion outlets are independently operably coupled to different common ion optics. Further provided herein are methods or reduced-pressure field asymmetric ion mobility devices wherein a frequency of at least one of the at least two sinusoids is about 100 kHz to about 2 MHz (e.g., about 100 kHz, about 500 kHz, about 750 kHz, about 1 MHz, about 1.5 MHz, or about 2 MHz). Further provided herein are methods or reduced-pressure field asymmetric ion mobility devices wherein an absolute value of the maximum amplitude of the waveform is about 100 V to about 2000V (e.g., about 250 V to about 1750 V, about 500 V to about 1500 V, about 750 V to about 1000 V, about 100 V, about 300 V, about 500V, about 700 V, about 1000V, about 1500 V, or about 2000 V). Further provided herein are methods or reduced-pressure field asymmetric ion mobility devices wherein an overall duty cycle of the waveform delivered by the one or more power supplies is about 5% to about 90% (e.g., about 5%, about 10%, about 20%, about 30%, about 50%, or about 90%). Further provided herein are methods or reduced-pressure field asymmetric ion mobility devices wherein the waveform is delivered to the inner electrode. Further provided herein are methods or reduced-pressure field asymmetric ion mobility devices wherein the waveform is delivered to the outer electrode. Further provided herein are methods or reduced-pressure field asymmetric ion mobility devices wherein the ion inlet extends generally parallel to a direction of ion movement between the inner electrode and the outer electrode. Further provided herein are methods or reduced-pressure field asymmetric ion mobility devices wherein the ion inlet extends at angle to a direction of ion movement between the inner electrode and the outer electrode, wherein the angle is about 20° to about 70° (e.g., about 30° to about 60°, or about 40° to about 50 °). Further provided herein are methods or reduced-pressure field asymmetric ion mobility devices wherein the ion outlet extends generally parallel to a direction of ion movement between the inner electrode and the outer electrode. Further provided herein are methods or reduced-pressure field asymmetric ion mobility devices wherein the ion outlet extends at angle to a direction of ion movement between the inner electrode and the outer electrode, wherein the angle is about 60° to about 120° (e.g., about 70° to about 110°, about 80° to about 90°). Further provided herein are methods or reduced-pressure field asymmetric ion mobility devices wherein the ion inlet and the ion outlet are substantially aligned along a common axis. Further provided herein are methods or reduced-pressure field asymmetric ion mobility devices wherein the ion inlet and the ion outlet are aligned with axes which are substantially perpendicular to each other. Further provided herein are methods or reduced-pressure field asymmetric ion mobility devices wherein the ion inlet is aligned along a first axis and the ion outlet is aligned along a second axis, the first and second axes being aligned substantially parallel to each other. Further provided herein are methods or reduced-pressure field asymmetric ion mobility devices wherein the ion inlet is aligned along a first axis and the ion outlet is aligned along a second axis, the first and second axes being aligned such that the first axis and the second axis form an angle of about 40° to about 120° at their intersection (e.g., about 45°, about 60°, about 75°, about 100°, or about 120°). Further provided herein are methods or reduced-pressure field asymmetric ion mobility devices wherein the inert gas is nitrogen, helium, or argon. Further provided herein are methods or reduced-pressure field asymmetric ion mobility devices wherein the reduced-pressure field asymmetric ion mobility device is configured for transmission of ions having m/z values of about 400 to about 900. Further provided herein are methods or reduced-pressure field asymmetric ion mobility devices wherein the reduced-pressure field asymmetric ion mobility device is configured to remove at least about 80% of singly charged ions within the first 50% of the distance between the inlet and the outlet (e.g., at least about 85%, at least about 90%, at least about 95%, at least about 98%, or at least about 99%). Further provided herein are methods or reduced-pressure field asymmetric ion mobility devices wherein the reduced-pressure field asymmetric ion mobility device is configured to resolve singly charged ions from multiply charged ions in a radial direction about the central axis of the enclosed mobility chamber. Further provided herein are methods or reduced-pressure field asymmetric ion mobility devices wherein the radial resolution of multiply charged species from singly charged species is at least about 2 mm on average (e.g., at least 2 mm, at least 5 mm, at least 10 mm, at least 12 mm, or at least 20 mm) when measured at the ion outlet. Further provided herein are methods or reduced-pressure field asymmetric ion mobility devices wherein the reduced-pressure field asymmetric ion mobility device further comprises one or more sets of ion optics configured to guide ions into the ion inlet, out of the ion outlet, or a combination thereof. Further provided herein are methods or reduced-pressure field asymmetric ion mobility devices wherein the one or more sets of ion optics each independently comprise: one or more ion funnels, one or more DC lenses, or combinations of two or more thereof. Further provided herein are methods or reduced-pressure field asymmetric ion mobility devices wherein the one or more sets of ion optics are configured to guide ions from the ion outlet into a traveling-wave ion mobility device. Further provided herein are methods or reduced-pressure field asymmetric ion mobility devices wherein the traveling-wave ion mobility device comprises a plurality of RF electrodes and guard electrodes disposed within a vacuum system configured to maintain a pressure within the traveling-wave ion mobility device which is less than the pressure of the inert gas within the enclosed mobility chamber of the reduced-pressure field asymmetric ion mobility device. Further provided herein are methods or reduced-pressure field asymmetric ion mobility devices wherein an average ion transmission efficiency of multiply charged ions from the ion inlet to the ion outlet is at least about 50% (e.g., at least about 50%, at least about 70%, at least about 80%, at least about 90%, or at least about 95%). Further provided herein are methods or reduced-pressure field asymmetric ion mobility devices wherein an average ion transmission efficiency of singly-charged ions from the ion inlet to the ion outlet is no more than about 50%, (e.g., no more than about 50%, no more than about 30%, no more than about 10%, no more than about 5%, or no more than about 1%). Further provided herein are methods or reduced-pressure field asymmetric ion mobility devices wherein multiply charged ions are transmitted from the ion inlet to the ion outlet in less than about 100 milliseconds (e.g., less than about 50 ms, 25 ms, 10 ms, 5 ms, or 3 ms). Further provided herein are methods or reduced-pressure field asymmetric ion mobility devices wherein multiply charged ions are transmitted from the ion inlet to the ion outlet in about 0.1 ms to about 10 ms, about 0.5 ms to about 5 ms, or about 1 ms to about 3 ms. Further provided herein are methods or reduced-pressure field asymmetric ion mobility devices wherein a pressure of the gas at the inlet is about 0.1 torr to about 10 torr greater than a pressure of the gas at the outlet (e.g., about 0.5torr to about 8, about 1 torr to about 5 torr, or about 1 torr to about 3 torr). Further provided herein are methods or reduced-pressure field asymmetric ion mobility devices wherein the differential deflection is configured to selectively remove ions having mobilities that correspond to singly charged species have a mass of about 400 Da or less (e.g., about 300 Da or less, about 200 Da or less, or about 100 Da or less). Further provided herein are methods or reduced-pressure field asymmetric ion mobility devices wherein the singly charged species are solvents used for electrospray ionization of a sample. Further provided herein are methods or reduced-pressure field asymmetric ion mobility devices wherein about 5%-50%, about 10%-40%, or about 20%-35% of the ions are selectively removed by the ion mobility device. Further provided herein are methods or reduced-pressure field asymmetric ion mobility devices wherein the gas moves through the ion mobility device at a velocity of about 10 m/s to about 300 m/s, or about 50 m/s to about 200 m/s. Further provided herein are methods or reduced-pressure field asymmetric ion mobility devices wherein the device further comprises a ring-shaped conduit having openings configured to feed the inert gas into the device. Further provided herein are methods or reduced-pressure field asymmetric ion mobility devices wherein the ring-shaped conduit abuts the outer electrode near the ion inlet. Further provided herein are methods or reduced-pressure field asymmetric ion mobility devices wherein a non-conductive support is coupled between the inner electrode and the outer electrode. Further provided herein are methods or reduced-pressure field asymmetric ion mobility devices wherein a non-conductive support is coupled between the inner electrode and a portion of the device assembly. Further provided herein are methods or reduced-pressure field asymmetric ion mobility devices wherein in the non-conductive support comprise conductive material extending through the non-conductive support, and wherein the conductive material is electrically coupled to the inner electrode and at least one of the power supplies. Further provided herein are methods or reduced-pressure field asymmetric ion mobility devices wherein the non-conductive support is a non-conductive fastener (e.g., a screw). Further provided herein are methods or reduced-pressure field asymmetric ion mobility devices wherein the non-conductive support comprises a C-shaped clamp. Further provided herein are methods or reduced-pressure field asymmetric ion mobility devices wherein the device comprises 2, 3, 4, or more than 4 non-conductive supports. Further provided herein are methods or reduced-pressure field asymmetric ion mobility devices wherein the inner electrode comprises one or more openings configured for ions to move through the openings and along a central axis inside the inner electrode towards the ion outlet. Further provided herein are methods or reduced-pressure field asymmetric ion mobility devices wherein one or more non-conductive supports are coupled between the inner electrode and the outer electrode, and wherein the non-conductive supports are disposed between the openings and the ion outlet. Further provided herein are methods or reduced-pressure field asymmetric ion mobility devices wherein the one or more non-conductive supports are positioned in the device such that at least 80% of the ions (e.g., at 90%, at least 95%, at least 98%, or at least 99%) entering the ion inlet do not contact the non-conductive supports. Further provided herein are methods or reduced-pressure field asymmetric ion mobility devices wherein a plurality of conductive supports extends from the inner electrode to the ion outlet, and wherein the conductive supports are electrically coupled to the inner electrode and at least one power supply. Further provided herein are methods or reduced-pressure field asymmetric ion mobility devices wherein each segment is attached to at least one non-conductive support. Further provided herein are methods or reduced-pressure field asymmetric ion mobility devices wherein the inner electrode comprises: a first tubular body having a first portion with a first diameter and a second portion with a second diameter, wherein the first portion is between the inlet of the device and the second portion, and wherein the first diameter is larger than the second diameter; and a second tubular body having one or more protrusions located at a first end of the second tubular body, wherein the protrusions of the second tubular body are fastened to the first tubular body in a configuration that allows ions to move between the protrusions and through an internal region between the second tubular body and the second portion of the first tubular body. Further provided herein are methods or reduced-pressure field asymmetric ion mobility devices wherein the protrusions are fastened to the first portion of the inner electrode. Further provided herein are methods or reduced-pressure field asymmetric ion mobility devices wherein the second tubular body comprises at least 2, at least 3, at least 4, or at least 5 protrusions. Further provided herein are methods or reduced-pressure field asymmetric ion mobility devices wherein the second tubular body comprises no more than 20, no more than 10, no more than 5, or no more than 4 protrusions. Further provided herein are methods or reduced-pressure field asymmetric ion mobility devices further comprising a non-conductive, ring-shaped body positioned between the second tubular body and the outer electrode. Further provided herein are methods or reduced-pressure field asymmetric ion mobility devices wherein the ring-shaped body is positioned at the protrusions of the second tubular body, or between the protrusions of the second tubular body and the ion outlet. Further provided herein are methods or reduced-pressure field asymmetric ion mobility devices wherein the ring-shaped body impedes or prevents ion from moving between the second tubular body and the outer electrode.

Provided herein are ion optics comprising: an ion inlet; an ion outlet; and a plurality of electrodes disposed between the ion inlet and the ion outlet, wherein each electrode of the plurality of electrodes comprises: a ring-shaped outer region; an inner region; and one or more openings formed between the ring-shaped outer region and the inner region, wherein the ion optic is configured such that ions passing through the optic move from the ion inlet to the ion outlet through the one or more openings, wherein a cross-sectional area of the ring-shaped outer regions of the electrodes is smaller at the ion inlet than at the ion outlet, and wherein a cross-sectional area of the inner regions of the electrodes is smaller at the ion inlet than the ion outlet. Further provided herein are ion optics wherein the cross-sectional area of the ring-shaped outer regions of the electrodes increases between the ion inlet and outlet, and the cross-sectional area of the inner regions of the electrodes increases between the ion inlet and the ion outlet. Further provided herein are ion optics wherein each electrode of the plurality of electrodes further comprises one or more supporting members (e.g., one, two, three, four, five, or more) extending between the ring-shaped outer region and the inner region. Further provided herein are ion optics wherein the ion optic is configured to focus ions into a ring-shaped ion cloud that exits the ion outlet. Further provided herein are ion optics wherein the ion optic comprises at least 5, at least 10, at least 20, at least 30, or at least 50 electrodes. Further provided herein are ion optics wherein the ion optic comprises no more than 100, no more than 75, no more than 50, or no more than 30 electrodes. Further provided herein are ion optics wherein the ion optic further comprises one or more power supplies configured deliver a waveform to focus ions into a ring-shaped ion cloud that exits the ion outlet.

Provided herein are systems comprising: the reduced-pressure field asymmetric ion mobility device described herein; a first ion optic configured to focus ions toward the ion inlet of the reduced-pressure field asymmetric ion mobility device; a second ion optic configured to receive ions from an ion outlet of reduced-pressure field asymmetric ion mobility device.

Provided herein are systems comprising one or more ion optics described herein.

Provided herein are systems wherein a ratio of a cross-sectional area of the inner region of the electrode nearest the ion outlet a cross-sectional area of the inner electrode of the reduced-pressure field asymmetric ion mobility device is 3:1 to 1:3, 2:1 to 1:2, 1.5:1 to 1:1.5, 1.25:1 to 1:1.25, or 1.1:1 to 1:1.1.

Provided herein are systems wherein the ion optic is configured to produce an ion cloud shaped to fit within a region between the inner electrode and the outer electrode of the reduced-pressure field asymmetric ion mobility device.

Provided herein are systems further comprising a first screen disposed between the first ion optic and the ion inlet of the reduced-pressure field asymmetric ion mobility device.

Provided herein are systems further comprising a second screen disposed between the second ion optic and the ion outlet of the reduced-pressure field asymmetric ion mobility device.

Provided herein are methods comprising: separating a sample over time (e.g., by liquid chromatography); ionizing at least a portion of the sample as the sample is being separated; introducing the gas-phase ions from the separated sample into the reduced-pressure field asymmetric ion mobility device described herein to selectively remove singly-charged ions; introducing multiply-charged gas-phase ions from the field asymmetric waveform ion mobility device to a travelling wave ion mobility device to separate the multiply-charged ions based on mobility; sequentially introducing windows of ions having different ion mobilities from the travelling wave ion mobility spectrometry device into a collision cell and fragmenting the windows of ions; and sequentially analyzing the different windows of fragmented ions using a mass analyzer.

Provided herein are methods wherein introducing the gas-phase ions from the separated sample into the reduced-pressure field asymmetric ion mobility device comprises forming the gas-phase ions into a ring-shaped ion cloud using the ion optic described herein.

Provided herein are systems comprising: a liquid chromatography device configured to separate a sample over time; an electrospray ionization device configured to ionize the sample while being separated by the liquid chromatography device; the reduced-pressure field asymmetric ion mobility device described herein; a travelling wave ion mobility device configured to separate multiply-charged ions received from the field asymmetric waveform ion mobility device based on mobility; and a collision cell configured to fragment ion-mobility-sorted, multiply charged ions received from the travelling wave ion mobility device; and a mass analyzer configured to analyze the fragmented ions from the collision cell. Further provided herein are systems further comprising the ion optic described herein, wherein the ion optic is configured to deliver ions to the reduced-pressure field asymmetric ion mobility device. Further provided herein are systems wherein the mass analyzer is a time-of-flight mass analyzer. Further provided herein are systems wherein the mass analyzer is a multi-reflecting time-of-flight mass analyzer.

In some embodiments, the systems can be configured to perform any of the steps of any of the methods described herein or any of the method steps herein can be performed using any of the systems described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a computation multi-physics simulation of an example of a reduced-pressure field asymmetric ion mobility separation device (FAIMS) device as described herein, which can separate singly charged from multiply charged species. Devices described herein can be configured for particular ranges of ion mobilities. For example, the simulation shown describes a 3D representation of the ion separation gap between the inner and outer FAIMS electrode. The inner and outer metal structures are suppressed and not shown. AC/DC module in COMSOL Multiphysics was used to calculate the alternating voltage in the ion separation gap when a bi-sinusoidal waveform was applied to the inner electrode. The simulation uses a time dependent solver-for the image shown, a time step was captured when the solver applied a negative voltage or low period of the alternating voltage to the inner electrode. Darker shading indicates a greater negative electric potential (legend showing 0 to −539 volts). Freq(1) was 2×10⁶ Hz.

FIG. 2A illustrates an example geometry for a coaxial ion injection reduced-pressure FAIMS device which can offer high transmission due to a straight line of site into the high-field asymmetric separation region. Ions enter an inlet and exit an outlet moving in generally the same direction.

FIG. 2B illustrates an alternate example geometry for a coaxial reduced-pressure FAIMS device with an inline ion injection which can offer reduced fringe and/or parasitic electric field effects on an ion population in the device. Ions enter an inlet moving at an angle relative to a longitudinal axis of the electrodes and exit the outlet moving in a direction that is generally the same as a longitudinal axis of the electrodes.

FIGS. 3A-3B illustrate multiphysics modeling parameters used to generate the simulation data of FIG. 1 and FIGS. 4-8. Ions are introduced at a FAIMS device inlet, gas at the inlet is assumed not to expand (since the pressure differential at the inlet of FAIMS is low). A laminar flow model is used to develop gas flow along the FAIMS ion separation gap. A revolved axis was used to construct a 3D FAIMS geometry from a 2D axi-symmetrical sketch in a geometry similar to that illustrated in FIG. 2A. A time step solver was used to calculate electric field inside the FAIMS ion separation gap at every 10 ns for 5 ms (4 torr). A bi-sinusoidal waveform was used in simulation. An alternate square or rectangular waveform using a DC voltage can also be used, for example by switching between high and low voltages at a 1:3 duty cycle. FIG. 3A describes exemplary steps (left side) used for generating the model including identify physics; sketch geometry; sync physics nodes; apply finite element solver; and iterate. Sync physical nodes may further comprise variables (middle) RF (time dependent); DC (stationary); laminar flow (stationary); and charge particle tracing (time dependent). Additional elements in the model are shown in the right side. FIG. 3B depicts model parameters for the FAIMS interface, physical model properties, and time stepping.

FIGS. 4A-4B illustrates plots of simulation data for a computational multi-physics model of an example coaxial reduced-pressure FAIMS device. FIG. 4A represents Surface: Electric potential (V); the x-axis is labeled mm from −50 to 50 at 50 mm intervals; the y-axis is labeled mm from 0 to 300 at 20 mm intervals. Purple shading indicates the greatest negative electric potential, while red shading indicates the least negative electric potential (legend showing 0 to −539 volts). Freq(1) was 2×10⁶ Hz. The left edge of the FAIMS device in FIG. 4A comprised a higher negative voltage (−350 to −500), while the right edge comprised a lower negative voltage (0 to −150 V) which also extended to the base of the device. FIG. 4B represents Velocity magnitude (m/s) Arrow Surface: Velocity field; the x-ais is labeled mm from −50 to 50 at 50 mm intervals; the y-axis is labeled mm from 0 to 300 at 20 mm intervals. Blue shading indicates a smaller gas flow (m/s), while red shading indicates a higher gas flow (legend showing 80 to 0 m/s). In FIG. 4B, the center of the FAIMS device (region between the inner and the outer electrodes) comprised a gas flow of about 80 m/s, while at the sides (near the electrodes) gas flow decreases to about 0 m/s. Gas flow near the base of the device was about 40 to 70 m/s. All solutions were solved for separately and passed down to next solver. For example, electric field created by FAIMS CV in the ion separation gap was calculated first and then passed down as a solution to be integrated into the gas flow solution. As an ion moves in the ion separation gap its motion is determined by the aggregate effect of CV plus gas flow. Same is done with FAIMS RF solution. The ion separation gap for the example geometry was determined to be about 12.5 mm on average based on the traveling cross section of the ion beam. FAIMS devices as described herein can balance between gap distance and ion transmission. A narrower gap may lead to more diffusional/wall loss and reduced transmission. A wider gap may use higher voltages to produce an electric field within the ion separation gap to separate ions. In this example geometry, a CV of 500V is applied. There is no significant electrical force acting on the ions axially in the example. The motion of ions in the axial direction is largely determined by gas flow. In this model the boundary conditions are adjusted to produce 100-200 m/s linear velocity within the ion separation gap.

FIG. 5 illustrates a plot of a particle tracking test model showing particles of the same mass with a charge of 1+ (dark blue), 2+ (light blue), and 3+ (yellow). The model illustrates that a combination of bi-sinusoidal RF voltage, CV, and gas flow can transport ions through the gap to produce charge separation. Singly charged ions are not transmitted in this model, which is terminated at 1.0 ms or 170 mm into the example device. However, the gas speed is low enough to cause radial diffusional broadening of the ion beam as evident by a portion of the 2+ and 3+ ions colliding with the wall boundary of the inner electrode. Time was 0.002 seconds. The x-axis is labeled mm from −20 to 40 at 20 mm intervals; the y-axis is labeled mm from 0 to 150 at 10 mm intervals.

FIGS. 6A-6B illustrate plots of particle tracking for a longer section of the example device. Charge separation is seen between example ion populations at m/z 400 (2+, FIG. 6B), and m/z 100(1+, FIG. 6A). Both plots correspond to a separation gap of 12.5 mm and CV=−393.6 V. In this simulation gas flow was increased to reduce beam broadening due to diffusion, so the ion beam is a bit more compressed compared with FIG. 5. The singly charged particles penetrate deeper into the ion separation which gap clarifies the limits of using excessive gas flow. For both plots, the x-axis is labeled mm from −100 to 100 at 50 mm intervals; the y-axis is labeled mm from 0 to 300 at 20 mm intervals.

FIGS. 7A-7B illustrate plots of a particle tracking model for m/z 400 (FIG. 7A: 1+, FIG. 7B: 2+) showing charge separation of identical m/z 400 by charge state. The multiply charged ions exhibit greater transmission which is attributed to the superior radial confinement of ions by the alternating electric field. Time was 0.005 seconds. For both plots, the x-axis is labeled mm from −100 to 100 at 50 mm intervals; the y-axis is labeled mm from 0 to 300 at 20 mm intervals.

FIGS. 8A-8B illustrate plots of simulated transmission of m/z 400 (2+) through an example FAIMS device. More than 95% of all m/z 400 (2+) species are transmitted within 3 ms. The FAIMS device described offers speed and sensitivity suited for coupling with a fast downstream mass analyzer. FIG. 8A is labeled particle trajectories; the x-axis is labeled mm from −100 to 100 at 50 mm intervals; the y-axis is labeled mm from 0 to 300 at 20 mm intervals; time was 0.005 seconds. FIG. 8B is labeled Global: transmission probabilities; the x-axis is labeled time (ms) from 0 to 5 at 1 ms intervals; the y-axis is labeled transmission probability (1) from 0 to 0.9 at 0.1-unit intervals.

FIG. 9 shows an example geometry of a FAIMS device 900 as described herein. Laminar flow of inert gas (from right to left) through an ion inlet 905 results in movement of ions through an annular cross-section defined by the inner electrode 904 and outer electrode 903. Electrodes are held by an end cap 902. To achieve high transmission the ion transport gas is uniformly introduced in the gap using a ring structure pierced with multiple equally spaced holes. The ring slips onto the inlet end over the outer electrode 903. A single source of gas stream through the plurality of smaller holes injecting into the gap a gentle stream of ion transport gas, which eventually exits the FAIMS region into a tube lens 901 to extract ions.

FIG. 10 illustrates an alternate example geometry of a FAIMS device 1000 as described herein. This example illustrates that ions can be injected into the FAIMS device at various angles. Inline injection 1001 means ions enter the device along the x-axis and along y-axis for orthogonal injection. However, ions can also be introduced at any angle by stacking an array of RF/DC electrodes 1002 at the inlet of FAIMS 1003 and angling the bore in the stack to guide ions at angle of choice. Angle of ion introduction can impact the overall sensitivity of the device but in select scenarios an angled introduction maybe preferred to avoid repelling force created by fringing electric field from the inner FAIMS electrode.

FIG. 11 illustrates an alternate example geometry of a FAIMS device 1100 as described herein, which can further be adapted to interface with other ion separation devices such as standing wave ion mobility devices and/or mass analyzers. This configuration describes an inline ion injection and extraction. Ions can be introduced inline using an electrodynamic ion funnel 1101a as a compressed beam. The inner electrode 1103 is extracted back away from the exit of the ion funnel to reduce the impact of fringe fields from the FAIMS RF. Ions once inside the FAIMS device, form bands 1104a-d with radii unique to 1+, 2+, 3+ etc. Ions travel as a donut shaped beam in the FAIMS device; singly charged donuts 1104a discharge on the outer electrode and do not transit (dashed arrow). Trajectories of multiply charged ions (solid arrows) stay in resonance with CV+RF and exit the FAIMS device into another ion funnel 1101b. The electric field at the exit of the FAIMS device and radius of beam acceptance from the ion funnel aids in extracting near 100% of the ion beam from the FAIMS device.

FIG. 12 illustrates a further example schematic of a FAIMS device 1200 that contains segmented inner electrode 1201. A resistor chain connects the segmented electrodes, and a voltage drop across the resistor chain produces a gentle ion propelling DC electric field of 10 V/cm to 50 V/cm. The DC propulsion removes the need to use gas to transport ions. DC propulsion can provide a better control of the FWHM of the FAIMS peak and can be tuned to produce high sensitivity.

FIG. 13 illustrates a further example schematic of a FAIMS device 1300 as described herein, which utilizes a suspended wire 1301 as an inner electrode. The strength of the ion separation electric field in the FAIMS device is inversely proportional to the radius of the inner electrode. Replacing the inner electrode with a wire 1301 can produce stronger electric field. The wire structure can be suspended to permit inline injection and extraction. Given the front and back ion funnel are driven by sine waveform, the wire 1301 can be suspended from the last lens of the front funnel and first lens of the back funnel. The outer electrode can be applied with a phase shifted sine waveform. Ions in the FAIMS gap will experience a net effect of bi-sinusoidal waveform.

FIG. 14A is one view of a CAD drawing illustrating an example FAIMS device designed for use in conjunction with a mass spectrometer, as described herein. The opening on the left side is the ion inlet for the ion flux that is to be separated based on charge.

FIG. 14B is a cross-sectional view of the FAIMs device illustrated in FIG. 14A. Near the ion inlet is a channel for filling the device with an inert gas. The channel receives inert gas that flows out of a series of openings positioned radially near the outer electrode and ion inlet. The inert gas can flow axially along the channel between the inner electrode and outer electrode towards the ion outlet, which is a small channel extending perpendicular to the longitudinal axis of the outer electrode.

FIG. 14C is one view of the FAIMs device illustrated in FIG. 14A where the outer electrode and other components are translucent to show the internal structure.

FIG. 14D is an enlarged, cross-sectional view of the ion inlet of the FAIMs device illustrated in FIG. 14A. The inner electrode has a rounded end facing the ion inlet. Channels form a path for flowing inert gas through openings near the inlet to fill the device.

FIG. 14E is one view of the gas inlet components of the FAIMs devices illustrated in FIG. 14A. A conduit feeds gas into a ringed structure having openings to feed gas into the FAIMs device. The ring may be press-fitted to obtain an airtight seal.

FIG. 15 shows a computer system that is programmed or otherwise configured to implement methods provided herein.

FIG. 16 illustrates a schematic diagram of an example reduced pressure field asymmetric ion mobility spectrometry device 1600 as described herein. The example implementation shown was used to acquire data presented in FIGS. 17-21, and may be further coupled to a mass spectrometry system. The incoming ion beam path 1601 is shown entering an inlet capillary 1610 (1.0 mm ID with a heater) and then proceeding to enter a FAIMS region 1609. FAIMS inner electrode 1608 (OD-25 mm) and outer electrode 1607 (ID=35 mm) separate ions by mobility. The RF feed 1606 used is a rectangular waveform (shown as an inset to the right of figure). Separated ions then interact with metal wire 1605 connected to one or more ion detectors 1603. The device has an ion separation gap of 5 mm. Additional ports on the device include a blank 1602 and pumping port/pressure gauge 1604.

FIG. 17 illustrates a plot of experimental data for observed ion current of a test ion (reserpine) at a pressure of 10 torr in a coaxial field asymmetric ion mobility module according to embodiments provided herein as a function of FAIMS compensation voltage utilizing a rectangular waveform at a fixed duty cycle at three different FAIMS dispersion voltages (DVs): 500.0, 700.0, and 800.0 volts. The x-axis is labeled FAIMS CV (V) from −50 to 30 at 10-volt intervals; the y-axis is labeled current (nA) from 0.0 to 0.7 at 0.1 nanoamp intervals.

FIG. 18 illustrates a plot of experimental data measuring ion current of a test ion (reserpine) at a fixed FAIMS dispersion voltage of 800 V as a function of compensation voltage for three different duty cycles (25%, 33%, and 50%) utilizing a rectangular waveform for an example implementation of a coaxial field-asymmetric ion mobility device as described herein. The x-axis is labeled FAIMS CV (V) from −50 to 30 at 10-volt intervals; the y-axis is labeled current (nA) from 0.0 to 0.7 at 0.1 nanoamp intervals.

FIG. 19 illustrates a plot of experimental data measuring ion current for a peptide mixture at a dispersion voltage of 800V for an example implementation of a coaxial field-asymmetric ion mobility device as described herein, showing separation of ions by mobility. The x-axis is labeled FAIMS CV (V) from −50 to 30 at 10-volt intervals; the y-axis is labeled current (nA) from 0.0 to 0.8 at 0.2 nanoamp intervals.

FIG. 20 illustrates a plot of experimental data measuring ion current for a peptide mix at a dispersion voltage of 900V for an example implementation of a coaxial field-asymmetric ion mobility device as described herein, showing improved resolution of two ion populations by mobility. The x-axis is labeled FAIMS CV (V) from −50 to 30 at 10-volt intervals; the y-axis is labeled current (nA) from 0.0 to 0.5 at 0.1-unit intervals.

FIG. 21 illustrates a plot of an experimental measurement of a blank for the sample measured in FIGS. 19 and 20. The x-axis is labeled FAIMS CV (V) from −40 to 10 at 10-volt intervals; the y-axis is labeled current (nA) from 0.000 to 0.004 at 0.001 nanoamp intervals.

FIG. 22 illustrates a plot of a three-dimensional simulation using a computational multi-physics model of an example coaxial reduced-pressure FAIMS device. The simulation data shows gas flow velocity (m/s) at various cross-sectional slices along a coaxial ion mobility device as described herein and was conducted using an inlet pressure of 3.5 Torr and an outlet pressure of 1.5 Torr. The legend is labeled from 5 (dark blue) to 35 (dark red) at 5 m/s intervals. The z-axis is labeled meters from 0.00 to 0.1 at 0.05 m intervals; the x-axis is labeled 0 to 10×10⁻³ at 5×10⁻³ m intervals; and the y-axis labeled from 0 to −15×10⁻³ at 5×10⁻³ m intervals. For the slice at the lowest point of the z-axis (i.e., far left), the inner edge comprised a velocity of about 35 m/s, which rapidly decreased to less than 5 m/s towards the outer edge. For the next slice, the inner edge comprised a velocity of about 15 m/s, which rapidly decreased to less than 6 m/s towards the outer edge. The remaining eight slices shown comprised an approximately uniform velocity of less than 6 m/s.

FIG. 23 illustrates a plot of the simulation of FIG. 22, rescaled to show detailed gas velocity (m/s) further between the inlet and outlet. The legend is labeled from 0.2 (dark blue) to 1.2 (dark red) at 0.2 m/s unit intervals. The z-axis is labeled meters from 0.00 to 0.1 at 0.05 m intervals; the x-axis is labeled 0 to 10×10⁻³ at 5×10⁻³ m intervals; and the y-axis labeled from 0 to −15×10⁻³ at 5×10⁻³ m intervals. For the slice near 0.05 m (farthest left), the inner edge of the slices comprised a velocity of about 1.3 m/s, which decreased to about 0.2 at about 75% of the distance to the edge before increasing to about 0.3 m/s. The next slice (moving to the right) comprised an inner edge of about 0.6 m/s decreasing to about 0.2 m/s at the outer edge. The remaining four slices shown comprised a relatively uniform velocity of 0.4-0.5 m/s.

FIG. 24 illustrates a plot of a simulation of FIGS. 22 and 23 for slices of velocity magnitude (m/s). The legend is labeled from 0.25 (dark blue) to 0.35 (dark red) at 0.01 m/s unit intervals. The z-axis is labeled meters from 0.00 to 0.1 at 0.05 m intervals; the x-axis is labeled 0 to 10×10⁻³ at 5×10⁻³ m intervals; and the y-axis labeled from 0 to −15×10⁻³ at 5×10⁻³ m intervals. For all three slices shown, the inner edge of the slices comprised a velocity of about 0.31 m/s, which increased to about 0.35 m/s until midway through the slice, before tapering down to about 0.26 m/s at the outer edges.

FIG. 25A is a cross-sectional view of the longitudinal axis in one example of the FAIMS device 2500A. A non-conductive hermetic feedthrough is disposed through the outer electrode to provide an electrical contact to the inner electrode. The feedthrough may use a gasket, such as an O-ring 2501, to seal gas within the FAIMs device. A hole 2504 is threaded through the feedthrough for a spring connector 2502 to couple with the inner electrode 2505 to drive the waveform. The outer electrode 2506 has a polygonal cross-section (e.g., square or rectangle), which may improve the seal relative to curved surfaces. The use of more than one feedthrough to the inner electrode 2505 may add to reliability of feeding voltage to the inner electrode 2505. The apparatus may be immobilized by one or more nuts 2503a/2503b.

FIG. 25B is a cross-sectional along the transverse axis of the FAIMs device 2500A illustrated in FIG. 25A. The connector housing 2505 in some instances comprises plastic.

FIG. 26 illustrates one example of a FAIMS device 2600 with conductive supports 2604 (made of metal or comprising another conducting material). The inner electrode 2605 is supported by conductive supports 2604 that can hold the inner electrode 2605 in place and drive the waveform. The conductive supports 2604 are positioned near the outlet of the FAIMs device, which may comprise an ion funnel 2603. The outer electrode and gas inlet are not shown. The use of one or more conductive supports 2604 to support the inner electrode 2605 may allow for ions to enter and exit the FAIMs device along the longitudinal axis. A feedthrough for RF 2601 in some instances is also employed. The support or housing 2603 in some instances is comprised of a material such as polyether ether ketone (PEEK).

FIG. 27 illustrates one example of a FAIMS device 2700 with non-conductive supports. A C-shaped support 2705 made of non-conductive material supports the inner electrode 2701. The C-shaped support 2705 includes conductive material 2706 (e.g., including electrical connections) positioned through the support to drive the waveform to the inner electrode 2701. Non-conductive material screws 2704 are also positioned near the outlet to support the inner electrode 2701. The use of the supporting structures may allow for ions to enter and exit (ion exit 2707) the FAIMs device along the longitudinal axis. The outer electrode 2702 and first ion funnel 2703a and second ion funnel 2703b are also present in the device 2700.

FIG. 28 illustrates one example of a FAIMS device 2800 with non-conductive supports 2801 (exploded to show screw insertion positions). Two or more C-shaped supports 2803a/2803b support the inner electrode similar to the design shown in FIG. 27. The inner electrode has two separate bodies 2802a and 2802b. Ions enter from the left side and ions are selectively removed primarily before moving past the C-shaped support 2803b and into ion funnel 2805. Non-conductive screws 2806 in some instances are used to attach the C-shaped supports to the outer electrode 2804.

FIG. 29 illustrates one example of a FAIMS device 2900 having openings 2904 in the inner electrode 2907. Ions may enter the device from the left after passing through ion optics 2902a. Ions are selectively removed in the separation region 2901 before flowing through one or more openings 2904 in the inner electrode 2907. The ions may then flow through the central axis of the inner electrode 2907 until exiting the device. To the right of the openings, one or more non-conductive supports 2906 may support the inner electrode 2907 within the device (C-shaped structures are shown 2906) while also providing electrical connections 2905 to the inner electrode 2907. The openings divert the ions and gas 2903 flow away from the non-conductive supports 2906.

FIG. 30 illustrates one example of a FAIMS device 3000 having spring connector 3006 for electrically coupling the inner electrode 3007 to a power supply that can deliver the waveform. The connector assembly 3003 is imbedded in the outer electrode 3003 but separated from the outer electrode 3004 via a plastic insulator 3005. Ions travel from the first ion funnel entrance 3001 to the second ion funnel entrance 3002. A detail connector assembly is also depicted in FIGS. 25A-25B.

FIG. 31 illustrates one example of a supporting structure 3103 to position the inner electrode with a FAIMs device 3100. The supporting structure includes an opening 3105 for the inner electrode 3101 to be positioned within the supporting structure 3103. Screws or other fasteners 3102b can secure the inner electrode 3101 to the supporting structure 3103. Protruding portions extend radially towards the surface of the outer electrode (not shown). Screws or other fasteners 3102a may secure the outer electrode to the support structure at position 3104. This supporting structure 3103 may be used in conjunction with suitable structure to provide electrical potential to the inner electrode 3101, such as those illustrated in FIGS. 25A-25B or FIG. 27.

FIGS. 32A-32B illustrate one example of a FAIMs device 3200b having openings 3201 in the inner electrode 3200a. FIG. 32A illustrates a top view of a FAIMS device 3200a. The inner electrode 3206 includes a tubular body having a larger diameter near the inlet 3207 of the FAIMs device and a smaller diameter near the outlet 3208 of the FAIMs device. The inner electrode 3206 also includes an intermediate cylinder with protrusions (for example, three equidistant protrusions 3201 are shown) at one end for fastening the tubular body to intermediate cylinder (e.g., using screws 3209 as shown). The diameter of the tubular body gradually decreases in a region from the location of that the intermediate cylinder is fastened towards the outlet 3208. A ring-shaped insulator 3203 is positioned between the outer electrode 3205 and the intermediate cylinder to support the inner electrode 3205 in place. The ring-shaped insulator 3203 also prevents or impedes movement of gas containing ions between the intermediate cylinder and the outer electrode 3205. After passing through a first ion funnel 3204a, ions 3202 (dashed arrow) move between the outer the electrode 3205 and a portion of the tubular body having the larger diameter, and ions are selectively removed in this region. The remaining ions then move between the protrusions of the intermediate cylinder and flow between the intermediate cylinder and region of the tubular body having the smaller diameter before exiting the FAIMs device and into a second ion funnel 3204b. The inner electrode 3206 may be coupled with an appropriate power source (not shown) using suitable structures, such as the feedthrough depicted in FIG. 25A. The electrical coupling may be connected with the intermediate cylinder by passing through the ring-shaped insulator 3203 or may be positioned between the ring-shaped insulator 3203 and the outlet 3208, such that conductive components for driving the waveform to the inner electrode 3206 have limited or no exposure to ions moving through the FAIMs device.

FIGS. 33A-33B illustrate one example of an ion optic 3300 which may be used to deliver ions to a FAIMs device as disclosed herein. FIG. 33A depicts a front view of the ion optic including a stack of wheel-shaped electrodes 3301/3301a having an outer ring, a central body 3305 inside the ring, and one or more supporting structures 3304 extending between the central body to the outer ring. One or more openings 3306 are formed between the outer ring and central body for ions 3302 to move through from an ion inlet to an ion outlet of the ion optic. The cross-sectional area of the outer ring and central body may increase along the stack from the ion inlet to the ion outlet such that the cross-sectional area of the opening decreases (last electrode 3301a as viewed from back). Ions moving from the ion inlet to the ion outlet can be focused into a donut-shaped ion cloud 3302 before exiting the ion optic. The donut-shaped ion cloud may enter a FAIMs device as disclosed herein and have dimensions that can result in improved ion transmission and/or selectivity by the FAIMs device. A simplified view of ions 3302 entering FAIMs device 3303 is shown in FIG. 33B.

FIGS. 34A-34E illustrates one example of a FAIMS device 3400 comprising an ion outlet (e.g., slit or other opening shape described herein) 3406 in the outer electrode 3405 to outlet the ions out of the FAIMS interface 3401. Ions enter through the opening 3402 (e.g., from an electrospray ionization device, not shown) and enter a first ion funnel 3403a, followed by the FAIMS interface 3401 (comprising an inner 3404 and outer electrode 3405). Next, ions pass through the ion outlet 3406 in the outer electrode 3405 at a 90-degree angle into a second ion funnel 3403 b. FIG. 34A depicts an isometric view of the FAIMS device 3400. FIG. 34B depicts an exploded isometric view of the FAIMS device 3400. FIG. 34C depicts a cross-sectional view perpendicular to the initial path of the ions through the first ion funnel 3403a and the inner 3404 and outer electrode 3405 of the FAIMS. FIG. 34D depicts a cross-sectional view from the perspective of the second ion funnel 3403b viewing the ion outlet 3406. FIG. 34E depicts a cross-sectional view along the axis of the ion outlet 3406.

### DETAILED DESCRIPTION

While various embodiments of the disclosure have been shown and described herein, it will be obvious to those skilled in the art that such embodiments are provided by way of example only. Numerous variations, changes, and substitutions can occur to those skilled in the art without departing from the disclosure. It should be understood that various alternatives to the embodiments of the disclosure described herein can be employed. The section headings used herein are for organizational purposes only and are not to be construed as limiting the subject matter described.

### Definitions

Unless defined otherwise, all technical and scientific terms used herein have the same meaning as is commonly understood by one of skill in the art to which this disclosure belongs. All patents and publications referred to herein are incorporated by reference.

As used herein, “near simultaneous” generally refers to events which occur at nearly, but not exactly the same time. Near simultaneous can refer to parallel events which begin at different times (e.g., with start points within seconds or milliseconds of each other) or can refer to sequential events which occur in rapid succession (e.g., where the end of a first event occurs no more than milliseconds or hundreds of milliseconds before the start of a subsequent event).

As used herein, “dead time” and “dead-time” are used interchangeably and generally refer to a period of time during the operation of a mass spectrometer where one or more mass analyzers are not available to accept ions (such as when scanning an ion trap). Such dead time often causes ions to be diverted to waste.

As used herein, “quadrupole” generally refers to any device or method step relying on a combination of radiofrequency (or near radiofrequency AC) and DC fields to guide or selections from an ion flux traversing the AC and/or DC fields. Quadrupoles can take a diverse variety of forms, including but not limited to linear true quadrupoles (i.e. with four straight, parallel, guide rods to which the RF and DC are applied), bent or twisted quadrupoles, hexapoles, octopoles, flatapoles, and the like. Quadrupoles can generally be operated as mass to charge ratio filters or selectors, or as broadband ion guides (e.g., in RF only mode). Ion transmission and/or filtering through a quadrupole can generally be described using a Matthieu stability diagram or calculation.

As used herein, “ion optic” generally refers to any device or combination of devices that are capable of directing the path of an ion flux in a controlled manner. Non limiting examples include AC or DC lenses, quadrupoles, collision cells and the like.

As used herein, “mass analyzer” generally refers to a device which is capable of determining a mass to charge ratio and an intensity or a number of counts per second of one or more ions arriving at a detector comprised within the analyzer.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “biomolecule” refers to biological components that may be involved in corona formation, including, but not limited to, for example, proteins, polypeptides, polysaccharides, a sugar, a lipid, a lipoprotein, a metabolite, an oligonucleotide, metabolome or combination thereof. It is contemplated that the biomolecule coronas of distinct particles may contain some of the same biomolecules, may contain distinct biomolecules with regard to the other sensor elements, and/or may differ in level or quantity, type or conformation of the biomolecule that binds to each sensor element. In one embodiment, the biomolecule is selected from the group of proteins, nucleic acids, lipids, and metabolomes.

As used herein, the terms “amu”, “atomic mass units”, “m/z”, or “mass-to −charge ratio”, when used as a unit of measurement, are used interchangeably and generally refer to a mass-to −charge ratio in Thompsons (Th).

### Reduced-Pressure Coaxial Field Asymmetric Ion Mobility

High Field Asymmetric Waveform Ion Mobility Spectrometry (FAIMS) can separate gas-phase ions at atmospheric pressure. In FAIMS, the ions can be introduced into a mobility region (“FAIMS region”) across which a radio frequency (rf) waveform, the magnitude of which is referred to as dispersion voltage (DV), is applied such that the ions are alternately subjected to high and low electric fields. The waveform can be asymmetric; for example, the high field may be applied for one time unit followed by an opposite-polarity low field of half of the high field component applied for twice as long. For example, the RF voltage can be a sum of two separate RF voltages, where one RF voltage is a sine function, and another is the same sine function, but phase shifted by pi/2. The result is a bi-sinusoidal waveform having a low and high period with a 3:1 ratio of duration. Other ratios are possible. The field-dependent change in the mobility of the ions causes the ions to drift towards the walls of the separation region. Since the dependence of ion mobility on electric field strength can be ion specific, a separation of different types of ions one from the other and can be referred to as FAIMS separation. In order to transmit an ion of interest through FAIMS, an appropriate direct current compensation voltage (CV) can be applied to compensate for the drift of the ion of interest toward the analyzer wall. By varying the CV, different ions can be selectively transmitted through the FAIMS device (or selectively removed). Described herein are novel FAIMS devices which are capable of producing such separations at less than atmospheric pressure without significant loss of ion flux, resulting in high ion transmission.

When used with mass spectrometry (MS) and/or tandem liquid chromatography mass spectrometry (LC-MS), FAIMS devices described herein can provide an extra degree of selectivity without introducing prohibitively large drops in signal intensity, compared with the signal intensity without the FAIMS device being present. This selectivity is especially important and can significantly reduce chemical noise or other interferences for analyses where several interferences may be present, e.g., in biological samples.

In some embodiments, the FAIMS device may be used in a method for analyzing biological samples. These samples may include a large number of unique proteins (e.g., more than 500 unique proteins). In some embodiments, the biological sample may include peptides obtained by digestion of proteins in the biological sample. Peptides from the biological may be dissolved in a suitable solvent and ionized before entering a FAIMS device as disclosed herein. Singly charged solvent ions are selectively removed such that multiply charged peptide ions primarily exit the FAIMS device for further steps.

The biological sample may include, but not limited to, plasma, serum, lung lavage, cell lysates, menstrual blood, urine, muscle tissue, processed tissue samples, amniotic fluid, fluid cerebrospinal fluid, tears, saliva, semen, host cell protein, cell culture media, and the like. In some embodiments, the biological sample may be plasma or serum. In some embodiments, the biological sample is a biofluid.

In some embodiments, the biological sample may be incubated with a surface and the biomolecules adsorbed to the surfaces may be ionized before entering a FAIMS device as disclosed herein. In some embodiments, the biological sample may be incubated with a surface (e.g., particles) as described in U.S. Patent Application Publication Nos. 2021/0285957, 2012/0046184, or U.S. Pat. No. 11,598,779, which are incorporated by reference in their entirety, and the biomolecules adsorbed to the surfaces may be ionized before entering a FAIMS device as disclosed herein.

Described herein are coaxial FAIMS devices which are designed to efficiently separate ions based on their charge states and/or physical or chemical properties which affect ion mobility. A FAIMS device as described herein can be used for transmitting ions in the gas phase. The FAIMS devices can be selectively switchable between a first operating mode for transmitting ions with separation according to charge state and a second operating mode for transmitting ions without separation (e.g., using the device as an rf-only ion guide device).

Ions can be separated in FAIMS on the basis of the ion mobility dependent behavior of KH, the high field mobility constant, as a function of the applied electric field strength. The strength of the field can be described as E/N where E is the field in volts/cm and N is the number density of the bath gas. Therefore, application of lower voltages is appropriate under conditions of lower gas pressure while higher voltages are applied at higher gas pressure, in each case arriving at the same E/N. The behavior of ions in the FAIMS devices is generally based on changes in the mobility of the ion under conditions of changing E/N, which is often simplified to conditions of changing electric field strength.

Methods and coaxial FAIMS devices described herein can be used to discriminate between and/or separate analyte ions and background ions within an ion flux prior to analysis with one or more mass analyzer and or one or more secondary ion mobility separations devices downstream of the coaxial FAIMS device. Secondary Ion mobility systems can additional FAIMS devices, traveling-wave ion mobility spectrometry devices (TWIMS), trapped ion mobility spectrometry devices (TIMS), drift-tube ion mobility spectrometry devices (DT-IMS), and/or combinations thereof.

Combining FAIMS with TWIMS or another secondary ion mobility separation device can reduce or eliminate the need for a high resolution FAIMS separation. A reduced resolution requirement allows for operation of FAIMS at reduced pressure which reduces loss of ion flux usually associated with ion-neutral collisions and/or ion-ion recombination. FAIMS can act as a low duty cycle filter meaning while a set of conditions are applied to pass a class of ions, while ions outside the transmission conditions ions are removed. A FAIMS device can operate at reduced pressure, for example, between 1-10 Torr with enough resolution to separate between two aggregate class of ions, for example, a separation between singly charged chemical background species and multiply charged peptide ions. Singly charged ions can be removed, reducing the total ion flux, and multiply charged can be passed to downstream analysis, preserving the ions of interest and enhancing the performance of the subsequent TWIMS separation, which can be used to improve utilization of the mass analyzer, by separating peptides in time.

Methods and systems described herein can be used to isolate or enrich one ion population from another and/or resolve signal ions from background ions to increase signal to noise ratio. Reduced-pressure field asymmetric ion mobility devices of the disclosure can comprising any of, or any combination of: an enclosed mobility chamber having an ion inlet and an ion outlet disposed at opposite ends and configured to be filled with an inert gas at a pressure of less than atmospheric pressure; at least one inner electrode disposed longitudinally between the ion inlet and the ion outlet of the enclosed mobility chamber; at least one outer electrode disposed longitudinally between the ion inlet and the ion outlet of the enclosed mobility chamber, the outer electrode being disposed such that the inner electrode is at least partially enclosed within the outer electrode; and/or one or more power supplies configured deliver a waveform to the inner electrode or the outer electrode, the waveform being configured to differentially deflect ions having different ion mobilities based on interaction of the ions with the waveform and the inert gas, wherein the differential deflection is configured to selectively remove ions having mobilities that correspond to singly charged species prior to said species reaching the ion outlet.

Methods described herein can be used for separating singly charged ions from multiply charged ions or for isolating signal ions from background ions, and can each independently comprise any of, or any combination of a plurality of: providing an ion flux to an ion inlet of a reduced-pressure field asymmetric ion mobility device; applying the waveform using the one or more power supplies to thereby substantially prevent ions of the ion flux having mobilities that correspond to singly charged species from reaching the ion outlet of the reduced-pressure field asymmetric ion mobility device; and/or obtaining a multiply charged ion population at the ion outlet of the reduced-pressure field asymmetric ion mobility device which is enriched for ions that correspond to multiply charged species.

Reduced-pressure field asymmetric ion mobility devices of this disclosure can comprising any of, or any combination of: an enclosed mobility chamber having the ion inlet and an ion outlet disposed at opposite ends and configured to be filled with an inert gas at a pressure of less than atmospheric pressure; at least one inner electrode disposed longitudinally between the ion inlet and the ion outlet of the enclosed mobility chamber; at least one outer electrode disposed longitudinally between the ion inlet and the ion outlet of the enclosed mobility chamber, the outer electrode being disposed such that the inner electrode is at least partially enclosed within the outer electrode; and/or one or more power supplies configured deliver a waveform to the inner electrode or the outer electrode, the waveform being configured to differentially deflect ions having different ion mobilities based on interaction of the ions with the waveform and the inert gas, wherein the differential deflection is configured to selectively remove ions having mobilities that correspond to singly charged species prior to said species reaching the ion outlet;

The methods or the reduced-pressure field asymmetric ion mobility devices may comprise a pressure of gas inside the devices is less than about 700 torr (e.g., less than about 100 torr, less than about 10 torr, or less than about 5 torr).

In some embodiments, the pressure is about 0.5 Torr to about 100 Torr. In some embodiments, the pressure is about 100 Torr to about 50 Torr, about 100 Torr to about 20 Torr, about 100 Torr to about 10 Torr, about 100 Torr to about 5 Torr, about 100 Torr to about 3.5 Torr, about 100 Torr to about 3 Torr, about 100 Torr to about 1.5 Torr, about 100 Torr to about 1 Torr, about 100 Torr to about 0.5 Torr, about 50 Torr to about 20 Torr, about 50 Torr to about 10 Torr, about 50 Torr to about 5 Torr, about 50 Torr to about 3.5 Torr, about 50 Torr to about 3 Torr, about 50 Torr to about 1.5 Torr, about 50 Torr to about 1 Torr, about 50 Torr to about 0.5 Torr, about 20 Torr to about 10 Torr, about 20 Torr to about 5 Torr, about 20 Torr to about 3.5 Torr, about 20 Torr to about 3 Torr, about 20 Torr to about 1.5 Torr, about 20 Torr to about 1 Torr, about 20 Torr to about 0.5 Torr, about 10 Torr to about 5 Torr, about 10 Torr to about 3.5 Torr, about 10 Torr to about 3 Torr, about 10 Torr to about 1.5 Torr, about 10 Torr to about 1 Torr, about 10 Torr to about 0.5 Torr, about 5 Torr to about 3.5 Torr, about 5 Torr to about 3 Torr, about 5 Torr to about 1.5 Torr, about 5 Torr to about 1 Torr, about 5 Torr to about 0.5 Torr, about 3.5 Torr to about 3 Torr, about 3.5 Torr to about 1.5 Torr, about 3.5 Torr to about 1 Torr, about 3.5 Torr to about 0.5 Torr, about 3 Torr to about 1.5 Torr, about 3 Torr to about 1 Torr, about 3 Torr to about 0.5 Torr, about 1.5 Torr to about 1 Torr, about 1.5 Torr to about 0.5 Torr, or about 1 Torr to about 0.5 Torr. In some embodiments, the pressure is about 100 Torr, about 50 Torr, about 20 Torr, about 10 Torr, about 5 Torr, about 3.5 Torr, about 3 Torr, about 1.5 Torr, about 1 Torr, or about 0.5 Torr. In some embodiments, the pressure is at least about 100 Torr, about 50 Torr, about 20 Torr, about 10 Torr, about 5 Torr, about 3.5 Torr, about 3 Torr, about 1.5 Torr, or about 1 Torr. In some embodiments, the pressure is at most about 50 Torr, about 20 Torr, about 10 Torr, about 5 Torr, about 3.5 Torr, about 3 Torr, about 1.5 Torr, about 1 Torr, or about 0.5 Torr.

Methods or reduced-pressure field asymmetric ion mobility devices described herein can have a distance between the ion inlet and the ion outlet that is about 10 mm to about 700 mm (e.g., about 100 mm to about 500 mm., about 200 mm to about 400 mm, or about 250 mm to about 350 mm).

In some embodiments, the distance is about 10 mm to about 700 mm. In some embodiments, the distance is about 700 mm to about 500 mm, about 700 mm to about 400 mm, about 700 mm to about 300 mm, about 700 mm to about 250 mm, about 700 mm to about 200 mm, about 700 mm to about 150 mm, about 700 mm to about 100 mm, about 700 mm to about 50 mm, about 700 mm to about 10 mm, about 500 mm to about 400 mm, about 500 mm to about 300 mm, about 500 mm to about 250 mm, about 500 mm to about 200 mm, about 500 mm to about 150 mm, about 500 mm to about 100 mm, about 500 mm to about 50 mm, about 500 mm to about 10 mm, about 400 mm to about 300 mm, about 400 mm to about 250 mm, about 400 mm to about 200 mm, about 400 mm to about 150 mm, about 400 mm to about 100 mm, about 400 mm to about 50 mm, about 400 mm to about 10 mm, about 300 mm to about 250 mm, about 300 mm to about 200 mm, about 300 mm to about 150 mm, about 300 mm to about 100 mm, about 300 mm to about 50 mm, about 300 mm to about 10 mm, about 250 mm to about 200 mm, about 250 mm to about 150 mm, about 250 mm to about 100 mm, about 250 mm to about 50 mm, about 250 mm to about 10 mm, about 200 mm to about 150 mm, about 200 mm to about 100 mm, about 200 mm to about 50 mm, about 200 mm to about 10 mm, about 150 mm to about 100 mm, about 150 mm to about 50 mm, about 150 mm to about 10 mm, about 100 mm to about 50 mm, about 100 mm to about 10 mm, or about 50 mm to about 10 mm. In some embodiments, the distance is about 700 mm, about 500 mm, about 400 mm, about 300 mm, about 250 mm, about 200 mm, about 150 mm, about 100 mm, about 50 mm, or about 10 mm. In some embodiments, the distance is at least about 700 mm, about 500 mm, about 400 mm, about 300 mm, about 250 mm, about 200 mm, about 150 mm, about 100 mm, or about 50 mm. In some embodiments, the distance is at most about 500 mm, about 400 mm, about 300 mm, about 250 mm, about 200 mm, about 150 mm, about 100 mm, about 50 mm, or about 10 mm.

In some cases, a distance from a central axis of the enclosed mobility chamber to an outer surface of the at least one outer electrode is about 7 mm to about 50 mm (e.g., about 10 mm to about 40 mm, or about 15 mm to about 25 mm). In some embodiments, the distance from the central axis to the outer surface is about 5 mm to about 50 mm. In some embodiments, the distance from the central axis to the outer surface is about 5 mm to about 7 mm, about 5 mm to about 10 mm, about 5 mm to about 15 mm, about 5 mm to about 20 mm, about 5 mm to about 25 mm, about 5 mm to about 30 mm, about 5 mm to about 40 mm, about 5 mm to about 50 mm, about 7 mm to about 10 mm, about 7 mm to about 15 mm, about 7 mm to about 20 mm, about 7 mm to about 25 mm, about 7 mm to about 30 mm, about 7 mm to about 40 mm, about 7 mm to about 50 mm, about 10 mm to about 15 mm, about 10 mm to about 20 mm, about 10 mm to about 25 mm, about 10 mm to about 30 mm, about 10 mm to about 40 mm, about 10 mm to about 50 mm, about 15 mm to about 20 mm, about 15 mm to about 25 mm, about 15 mm to about 30 mm, about 15 mm to about 40 mm, about 15 mm to about 50 mm, about 20 mm to about 25 mm, about 20 mm to about 30 mm, about 20 mm to about 40 mm, about 20 mm to about 50 mm, about 25 mm to about 30 mm, about 25 mm to about 40 mm, about 25 mm to about 50 mm, about 30 mm to about 40 mm, about 30 mm to about 50 mm, or about 40 mm to about 50 mm. In some embodiments, the distance from the central axis to the outer surface is about 5 mm, about 7 mm, about 10 mm, about 15 mm, about 20 mm, about 25 mm, about 30 mm, about 40 mm, or about 50 mm. In some embodiments, the distance from the central axis to the outer surface is at least about 5 mm, about 7 mm, about 10 mm, about 15 mm, about 20 mm, about 25 mm, about 30 mm, or about 40 mm. In some embodiments, the distance from the central axis to the outer surface is at most about 7 mm, about 10 mm, about 15 mm, about 20 mm, about 25 mm, about 30 mm, about 40 mm, or about 50 mm.

In some cases, a distance from a central axis of the enclosed mobility chamber to an outer surface of the at least one inner electrode is about 0.2 mm to about 20 mm (e.g., about 1 mm to about 15 mm, or about 3 mm to about 10 mm). In some embodiments, the distance from the central axis to the outer surface is about 0.2 mm to about 20 mm. In some embodiments, the distance from the central axis to the outer surface is about 0.2 mm to about 0.5 mm, about 0.2 mm to about 1 mm, about 0.2 mm to about 3 mm, about 0.2 mm to about 5 mm, about 0.2 mm to about 10 mm, about 0.2 mm to about 15 mm, about 0.2 mm to about 20 mm, about 0.5 mm to about 1 mm, about 0.5 mm to about 3 mm, about 0.5 mm to about 5 mm, about 0.5 mm to about 10 mm, about 0.5 mm to about 15 mm, about 0.5 mm to about 20 mm, about 1 mm to about 3 mm, about 1 mm to about 5 mm, about 1 mm to about 10 mm, about 1 mm to about 15 mm, about 1 mm to about 20 mm, about 3 mm to about 5 mm, about 3 mm to about 10 mm, about 3 mm to about 15 mm, about 3 mm to about 20 mm, about 5 mm to about 10 mm, about 5 mm to about 15 mm, about 5 mm to about 20 mm, about 10 mm to about 15 mm, about 10 mm to about 20 mm, or about 15 mm to about 20 mm. In some embodiments, the distance from the central axis to the outer surface is about 0.2 mm, about 0.5 mm, about 1 mm, about 3 mm, about 5 mm, about 10 mm, about 15 mm, or about 20 mm. In some embodiments, the distance from the central axis to the outer surface is at least about 0.2 mm, about 0.5 mm, about 1 mm, about 3 mm, about 5 mm, about 10 mm, or about 15 mm. In some embodiments, the distance from the central axis to the outer surface is at most about 0.5 mm, about 1 mm, about 3 mm, about 5 mm, about 10 mm, about 15 mm, or about 20 mm.

In some cases, a distance from an outer surface of the at least one inner electrode to an inner surface of the at least one outer electrode is about 5 mm to about 40 mm (e.g., about 5 mm to about 30 mm, about 8 mm to about 20 mm, or about 10 mm to about 15 mm).

In some cases, one or more power supplies provide a waveform comprising a sinusoidal waveform, a square waveform, a triangular waveform, a sawtooth waveform, or combinations of one or more thereof. In some cases, one or more power supplies provide a waveform comprising at least two waveforms which are phase-shifted with respect to each other. In some cases, a phase-shift between waveforms is about 30° to about 120° (e.g., about 30°, about 45°, about 60°, about 90°, or about 120°). In some cases, the at least two waveforms are sinusoids. In some cases, the at least two waveforms have different amplitudes.

A frequency of any of the waveforms used herein may independently be 100 kHz to about 2 MHz (e.g., about 100 kHz, about 500 kHz, about 750 kHz, about 1 MHz, about 1.5 MHz, or about 2 MHz). In some embodiments, the frequency is about 100 kHz to about 1,000 kHz. In some embodiments, the frequency is about 100 kHz to about 200 kHz, about 100 kHz to about 300 kHz, about 100 kHz to about 400 kHz, about 100 kHz to about 500 kHz, about 100 kHz to about 750 kHz, about 100 kHz to about 1,000 kHz, about 200 kHz to about 300 kHz, about 200 kHz to about 400 kHz, about 200 kHz to about 500 kHz, about 200 kHz to about 750 kHz, about 200 kHz to about 1,000 kHz, about 300 kHz to about 400 kHz, about 300 kHz to about 500 kHz, about 300 kHz to about 750 kHz, about 300 kHz to about 1,000 kHz, about 400 kHz to about 500 kHz, about 400 kHz to about 750 kHz, about 400 kHz to about 1,000 kHz, about 500 kHz to about 750 kHz, about 500 kHz to about 1,000 kHz, or about 750 kHz to about 1,000 kHz. In some embodiments, the frequency is about 100 kHz, about 200 kHz, about 300 kHz, about 400 kHz, about 500 kHz, about 750 kHz, or about 1,000 kHz. In some embodiments, the frequency is at least about 100 kHz, about 200 kHz, about 300 kHz, about 400 kHz, about 500 kHz, or about 750 kHz. In some embodiments, the frequency is at most about 200 kHz, about 300 kHz, about 400 kHz, about 500 kHz, about 750 kHz, or about 1,000 kHz. In some embodiments, the frequency is about 1 MHz to about 2 MHz. In some embodiments, the frequency is about 1 MHz to about 1.25 MHz, about 1 MHz to about 1.5 MHz, about 1 MHz to about 1.75 MHz, about 1 MHz to about 2 MHz, about 1.25 MHz to about 1.5 MHz, about 1.25 MHz to about 1.75 MHZ, about 1.25 MHz to about 2 MHz, about 1.5 MHz to about 1.75 MHz, about 1.5 MHz to about 2 MHZ, or about 1.75 MHz to about 2 MHz. In some embodiments, the frequency is about 1 MHz, about 1.25 MHz, about 1.5 MHz, about 1.75 MHz, or about 2 MHz. In some embodiments, the frequency is at least about 1 MHz, about 1.25 MHz, about 1.5 MHz, or about 1.75 MHz. In some embodiments, the frequency is at most about 1.25 MHz, about 1.5 MHz, about 1.75 MHz, or about 2 MHz.

An absolute value of the maximum amplitude of any of the waveforms used may be about 100 V to about 2000 V (e.g., about 250 V to about 1750 V, about 500 V to about 1500 V, about 750 V to about 1000 V, about 100 V, about 300 V, about 500V, about 700 V, about 1000V, about 1500 V, or about 2000 V).

A reduced-pressure field asymmetric ion mobility device of any may comprise an overall duty cycle of the waveform delivered by the one or more power supplies is about 5% to about 90% (e.g., about 5%, about 10%, about 20%, about 30%, about 50%, or about 90%). In some embodiments, the duty cycle is about 5% to about 90%. In some embodiments, the duty cycle is about 5% to about 10 %, about 5% to about 20%, about 5% to about 30%, about 5% to about 50%, about 5% to about 60%, about 5% to about 80%, about 5% to about 90%, about 10% to about 20%, about 10% to about 30%, about 10% to about 50%, about 10% to about 60%, about 10% to about 80%, about 10% to about 90%, about 20% to about 30%, about 20% to about 50%, about 20% to about 60%, about 20% to about 80%, about 20% to about 90%, about 30% to about 50%, about 30% to about 60%, about 30% to about 80%, about 30% to about 90%, about 50% to about 60%, about 50% to about 80%, about 50% to about 90%, about 60% to about 80%, about 60% to about 90%, or about 80% to about 90%. In some embodiments, the duty cycle is about 5%, about 10%, about 20%, about 30%, about 50%, about 60%, about 80%, or about 90%. In some embodiments, the duty cycle is at least about 5%, about 10%, about 20%, about 30%, about 50%, about 60%, or about 80%. In some embodiments, the duty cycle is at most about 10%, about 20%, about 30%, about 50%, about 60%, about 80%, or about 90%.

Waveforms used in devices and methods described herein may each be delivered or otherwise applied independently to the inner electrode or the outer electrode.

In some cases, an ion inlet extends generally parallel to a direction of ion movement between the inner electrode and the outer electrode. In some cases, an ion inlet extends at angle to a direction of ion movement between the inner electrode and the outer electrode, wherein the angle is about 20° to about 70° (e.g., about 30° to about 60°, or about 40° to about 50°). In some cases, an ion outlet extends generally parallel to a direction of ion movement between the inner electrode and the outer electrode. In some cases, an ion outlet extends at angle to a direction of ion movement between the inner electrode and the outer electrode, wherein the angle is about 60° to about 120° (e.g., about 70° to about 110°, about 80° to about 90°). In some cases, an ion inlet and the ion outlet are substantially aligned along a common axis.

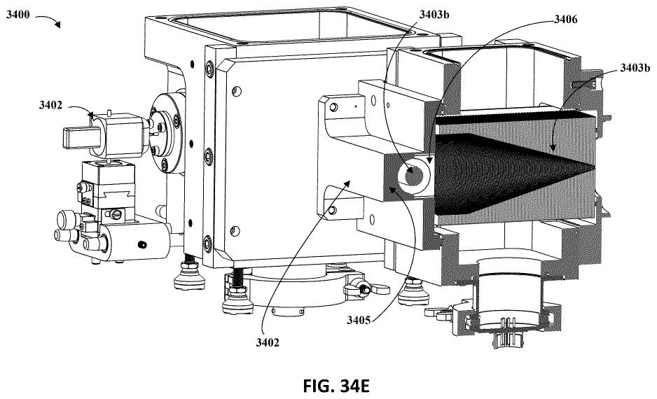

In some cases, the ion outlet may be an opening in the outer electrode. In some cases, the opening is a tubular conduit extending at an angle (e.g., about 90°) with the longitudinal axis of the outer electrode. In some cases, the opening may be a slit extending at an angle (e.g., about 90°) with the longitudinal axis of the outer electrode. In some cases, the slit may extend at least about 15%, at least about 30%, at least about 45%, or at least about 50% around the circumference of the outer electrode. For example, the slit may form a ‘half-moon’ shape around the outer electrode. In some cases, the outlet may be operably coupled to an ion funnel, which can focus ions that exit the ion outlet. For example, an ion funnel may receive ions exiting a slit in the outer electrode before the ions may be analyzed using a mass analyzer. In some instances, the method or the reduced-pressure field asymmetric ion mobility device comprises the configuration depicted in FIGS. 34A-34E.

In some cases, the method or the reduced-pressure field asymmetric ion mobility device may include a plurality of ion outlets. For example, two slits in the outer electrode may form two ion outlets. In some cases, the plurality of ion outlets may be operably coupled to a common ion optic (e.g., ion funnel) for analysis using a single mass analyzer. In some cases, at least a portion of the plurality of outlets may be coupled to different ion optics (e.g., different ion funnels) for analysis using different mass analyzers.

Ion inlets and ion outlets of this disclosure can be aligned with axes which are substantially perpendicular to each other. In some cases, ion inlets are aligned along a first axis and the ion outlet is aligned along a second axis, the first and second axes being aligned substantially parallel to each other.

In some cases, the ion inlet is aligned along a first axis and the ion outlet is aligned along a second axis, the first and second axes being aligned such that the first axis and the second axis form an angle of about 40° to about 120° at their intersection (e.g., about 45°, about 60°, about 75°, about 100°, or about 120°). In some cases, the inert gas used is nitrogen, helium, or argon. In some cases, the reduced-pressure field asymmetric ion mobility device is configured for transmission of ions having m/z values of about 400 to about 900. In some cases, the reduced-pressure field asymmetric ion mobility device is configured for transmission of ions having m/z values greater than about 400 m/z. In some cases, the reduced-pressure field asymmetric ion mobility device is configured to remove ions having m/z values less than about 350 m/z.

Reduced-pressure field asymmetric ion mobility devices of the disclosure may be configured to remove at least about 80% of singly charged ions within the first 50% of the distance between the inlet and the outlet (e.g., at least about 85%, at least about 90%, at least about 95%, at least about 98%, or at least about 99%).

In some embodiments, a singly charged ion current passing through FAIMS devices of the disclosure is reduced or redirected to an alternate outlet of the device by about 50% to about 99.5%. In some embodiments, a singly charged ion current passing through FAIMS devices of the disclosure is reduced or redirected to an alternate outlet of the device by about 50% to about 60%, about 50% to about 70%, about 50% to about 80%, about 50% to about 95%, about 50% to about 90%, about 50% to about 95%, about 50% to about 99%, about 50% to about 99.5%, about 60% to about 70 %, about 60% to about 80%, about 60% to about 95%, about 60% to about 90%, about 60% to about 95%, about 60% to about 99%, about 60% to about 99.5%, about 70% to about 80%, about 70% to about 95%, about 70% to about 90%, about 70% to about 95%, about 70% to about 99%, about 70% to about 99.5%, about 80% to about 95%, about 80% to about 90%, about 80% to about 95%, about 80% to about 99%, about 80% to about 99.5%, about 95% to about 90%, about 95% to about 95%, about 95% to about 99%, about 95% to about 99.5%, about 90% to about 95%, about 90% to about 99%, about 90% to about 99.5%, about 95% to about 99%, about 95% to about 99.5%, or about 99% to about 99.5%. In some embodiments, a singly charged ion current passing through FAIMS devices of the disclosure is reduced or redirected to an alternate outlet of the device by about 50%, about 60%, about 70%, about 80%, about 95%, about 90%, about 95%, about 99 %, or about 99.5%. In some embodiments, a singly charged ion current passing through FAIMS devices of the disclosure is reduced or redirected to an alternate outlet of the device by at least about 50%, about 60%, about 70%, about 80%, about 95%, about 90%, about 95%, or about 99%. In some embodiments, a singly charged ion current passing through FAIMS devices of the disclosure is reduced or redirected to an alternate outlet of the device by at most about 60%, about 70%, about 80 %, about 95%, about 90%, about 95%, about 99%, or about 99.5%.

FAIMS devices of the disclosure may be configured to resolve singly charged ions from multiply charged ions in a radial direction about the central axis of the enclosed mobility chamber. In some cases, a radial resolution of multiply charged species from singly charged species is at least about 2 mm on average (e.g., at least 2 mm, at least 5 mm, at least 10 mm, at least 12 mm, or at least 20 mm) when measured at the ion outlet.

In some cases, reduced-pressure field asymmetric ion mobility devices comprise one or more sets of ion optics configured to guide ions into the ion inlet, out of the ion outlet, or a combination thereof. The one or more sets of ion optics may each independently comprise: one or more ion funnels, one or more DC lenses, or combinations of two or more thereof. In some cases, the one or more sets of ion optics are configured to guide ions from the ion outlet into a traveling-wave ion mobility device.

In some cases, the traveling-wave ion mobility device comprises a plurality of RF electrodes and guard electrodes disposed within a vacuum system configured to maintain a pressure within the traveling-wave ion mobility device which is less than the pressure of the inert gas within the enclosed mobility chamber of the reduced-pressure field asymmetric ion mobility device.

In some cases, an average ion transmission efficiency of multiply charged ions from the ion inlet to the ion outlet is at least about 50% (e.g., at least about 50%, at least about 70%, at least about 80%, at least about 90%, or at least about 95%). In some cases, an average ion transmission efficiency of singly charged ions from the ion inlet to the ion outlet is no more than about 50%, (e.g., no more than about 50%, no more than about 30%, no more than about 10%, no more than about 5%, or no more than about 1%).

In some cases, multiply charged ions are transmitted from the ion inlet to the ion outlet in less than about 100 milliseconds (e.g., less than about 50 ms, 25 ms, 10 ms, 5 ms, or 3 ms). In some cases, multiply charged ions are transmitted from the ion inlet to the ion outlet in about 0.1 ms to about 10 ms, about 0.5 ms to about 5 ms, or about 1 ms to about 3 ms. In some cases, a pressure of the gas at the inlet is about 0.1 torr to about 10 torr greater than a pressure of the gas at the outlet (e.g., about 0.5 torr to about 8, about 1 torr to about 5 torr, or about 1 torr to about 3 torr).

In some cases, the differential deflection is configured to selectively remove ions having mobilities that correspond to singly charged species have a mass of about 400 Da or less (e.g., about 300 Da or less, about 200 Da or less, or about 100 Da or less). In some cases, the singly charged species are solvents used for electrospray ionization of a sample. In some cases, about 5%-50%, about 10%-40%, or about 20%-35% of the ions are selectively removed by the ion mobility device. In some cases, the gas moves through the ion mobility device at a velocity of about 10 m/s to about 300 m/s, or about 50 m/s to about 200 m/s.

In some cases, the device further comprises a ring-shaped conduit having openings configured to feed the inert gas into the device. In some embodiments, the ring-shaped conduit abuts the outer electrode near the ion inlet. In some cases, a non-conductive support is coupled between the inner electrode and the outer electrode.

A non-conductive support may comprise conductive material extending through the non-conductive support, and wherein the conductive material is electrically coupled to the inner electrode and at least one of the power supplies. The non-conductive support may be a non-conductive fastener (e.g., a screw).

In some cases, the inner electrode comprises one or more openings configured for ions to move through the openings and along a central axis inside the inner electrode towards the ion outlet. One or more non-conductive supports may be coupled between the inner electrode and the outer electrode, and wherein the non-conductive supports are disposed between the openings and the ion outlet.

One or more non-conductive supports may be positioned in the device such that at least 80% of the ions (e.g., at 90%, at least 95%, at least 98%, or at least 99%) entering the ion inlet do not contact the non-conductive supports. In some cases, a plurality of conductive supports extends from the inner electrode to the ion outlet, and wherein the conductive supports are electrically coupled to the inner electrode and at least one power supply.

In some cases, the inner electrode may comprise: a first tubular body having a first portion with a first diameter and a second portion with a second diameter, wherein the first portion is between the inlet of the device and the second portion, and wherein the first diameter is larger than the second diameter; a second tubular body having one or more protrusions located at a first end of the second tubular body, wherein the protrusions of the second tubular body are fastened to the first tubular body in a configuration that allows ions to move between the protrusions and through an internal region between the second tubular body and the second portion of the first tubular body. In some cases, the protrusions are fastened to the first portion of the inner electrode. The second tubular body may comprise at least 2, at least 3, at least 4, or at least 5 protrusions. In some cases, the second tubular body comprises no more than 20, no more than 10, no more than 5, or no more than 4 protrusions.

FAIMS devices of this disclosure may comprise a non-conductive, ring-shaped body positioned between the second tubular body and the outer electrode. In some cases, a ring-shaped body is positioned at the protrusions of the second tubular body, or between the protrusions of the second tubular body and the ion outlet. The ring-shaped body may impede or prevent ion from moving between the second tubular body and the outer electrode.

Ion optics of this disclosure can comprise any of, or any combination of: an ion inlet; an ion outlet; and one or more (e.g., a plurality of) electrodes disposed between the ion inlet and the ion outlet, wherein each electrode of the one or more electrodes comprises: a ring-shaped outer region; an inner region; and one or more openings formed between the ring-shaped outer region and the inner region, wherein the ion optic is configured such that ions passing through the optic move from the ion inlet to the ion outlet through the one or more openings, and/or a cross-sectional area of the ring-shaped outer regions of the electrodes is smaller at the ion inlet than at the ion outlet, and wherein a cross-sectional area of the inner regions of the electrodes is smaller at the ion inlet than the ion outlet.

In some cases, a cross-sectional area of the ring-shaped outer regions of the electrodes increases between the ion inlet and outlet, and the cross-sectional area of the inner regions of the electrodes increases between the ion inlet and the ion outlet. In some cases, each electrode of the plurality of electrodes further comprises one or more supporting members (e.g., one, two, three, four, five, or more) extending between the ring-shaped outer region and the inner region. In some cases, ion optics are configured to focus ions into a ring-shaped ion cloud that exits the ion outlet. Ion optics can comprise at least 5, at least 10, at least 20, at least 30, or at least 50 electrodes. In some cases, ion optics comprise no more than 100, no more than 75, no more than 50, or no more than 30 electrodes. In some instances, one or more power supplies configured deliver a waveform to focus ions into a ring-shaped ion cloud that exits the ion outlet.

In some instances, any of the devices or systems of the disclosure can comprise a first ion optic configured to focus ions toward the ion inlet of the reduced-pressure field asymmetric ion mobility device. In some cases, a second ion optic may be configured to receive ions from an ion outlet of reduced-pressure field asymmetric ion mobility device. In some cases, a ratio of a cross-sectional area of the inner region of the electrode nearest the ion outlet a cross-sectional area of the inner electrode of the reduced-pressure field asymmetric ion mobility device is 3:1 to 1:3, 2:1 to 1:2, 1.5:1 to 1:1.5, 1.25:1 to 1:1.25, or 1.1:1 to 1:1.1. Ion optics may be configured to produce an ion cloud shaped to fit within a region between the inner electrode and the outer electrode of the reduced-pressure field asymmetric ion mobility device. A first screen may be disposed between the first ion optic and the ion inlet of the reduced-pressure field asymmetric ion mobility device. In some cases, a second screen disposed between the second ion optic and the ion outlet of the reduced-pressure field asymmetric ion mobility device.

Any of the methods of the disclosure can comprise any of, or any combination of: separating a sample over time (e.g., by liquid chromatography); ionizing at least a portion of the sample as the sample is being separated; introducing the gas-phase ions from the separated sample into the reduced-pressure field asymmetric ion mobility device described herein to selectively remove singly-charged ions; introducing multiply-charged gas-phase ions from the field asymmetric waveform ion mobility device to a travelling wave ion mobility device to separate the multiply-charged ions based on mobility; sequentially introducing windows of ions having different ion mobilities from the travelling wave ion mobility spectrometry device into a collision cell and fragmenting the windows of ions; and/or sequentially analyzing the different windows of fragmented ions using a mass analyzer.

In some cases, introducing the gas-phase ions from the separated sample into the reduced-pressure field asymmetric ion mobility device comprises forming the gas-phase ions into a ring-shaped ion cloud using any of the ion optics described herein.

Any of the systems of the disclosure may comprise any or any combination of: a liquid chromatography device configured to separate a sample over time; an electrospray ionization device configured to ionize the sample while being separated by the liquid chromatography device; a reduced-pressure field asymmetric ion mobility device as described herein; a travelling wave ion mobility device configured to separate multiply-charged ions received from the field asymmetric waveform ion mobility device based on mobility; a collision cell configured to fragment ion-mobility-sorted, multiply charged ions received from the travelling wave ion mobility device; and/or a mass analyzer (e.g., a time-of-flight mass analyzer) configured to analyze the fragmented ions from the collision cell. In some cases, one or more ion optics are configured to deliver ions to the reduced-pressure field asymmetric ion mobility device.

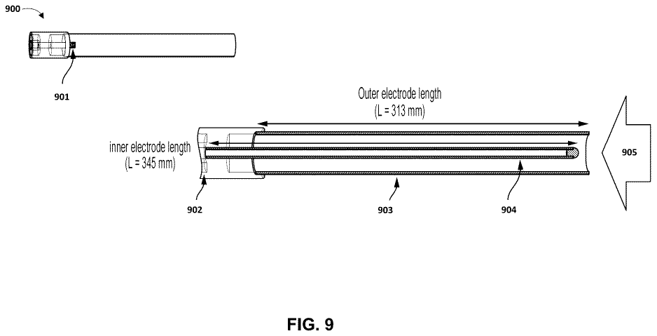

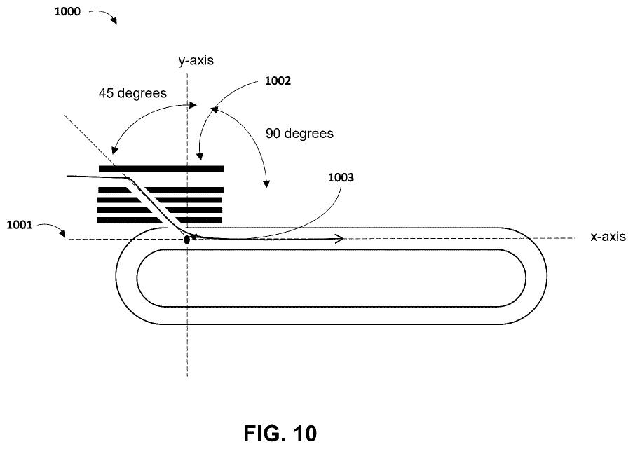

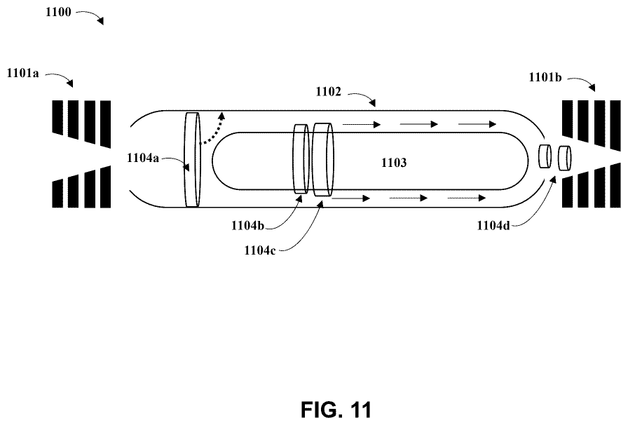

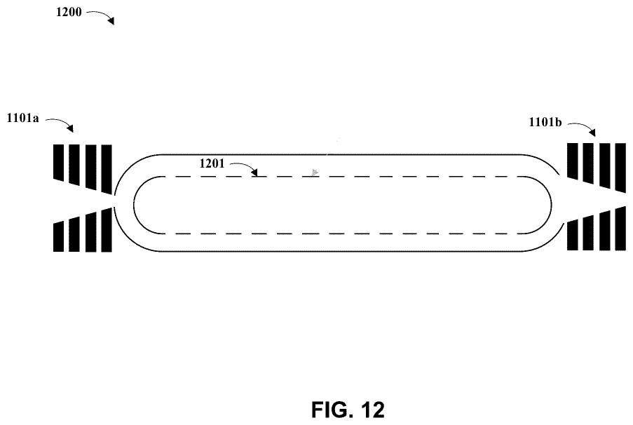

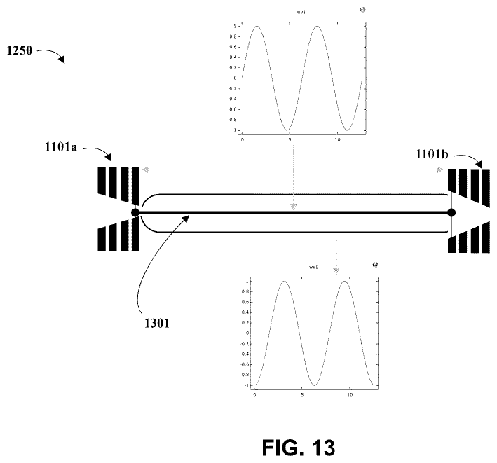

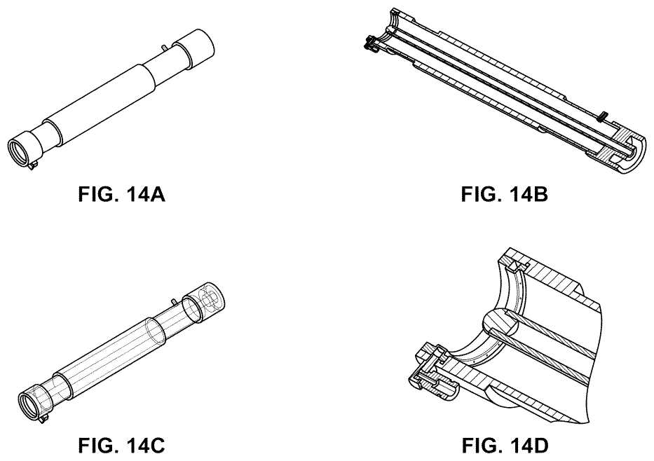

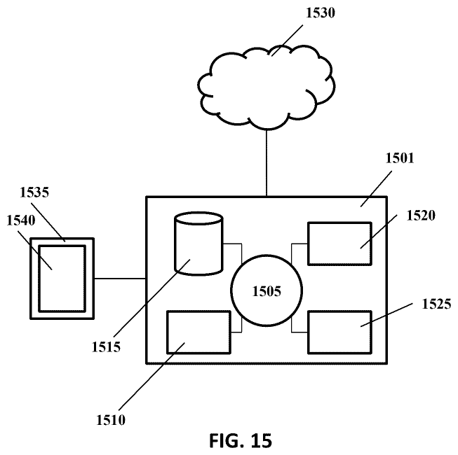

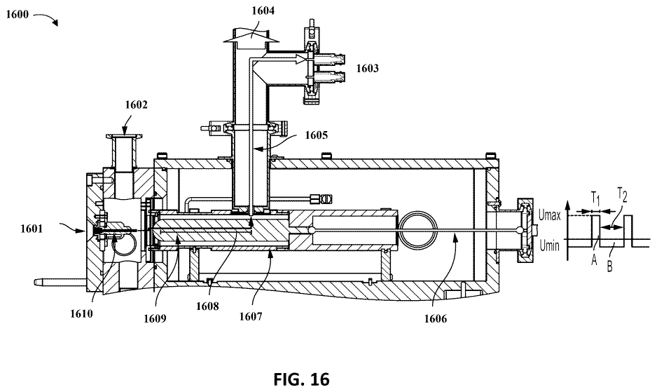

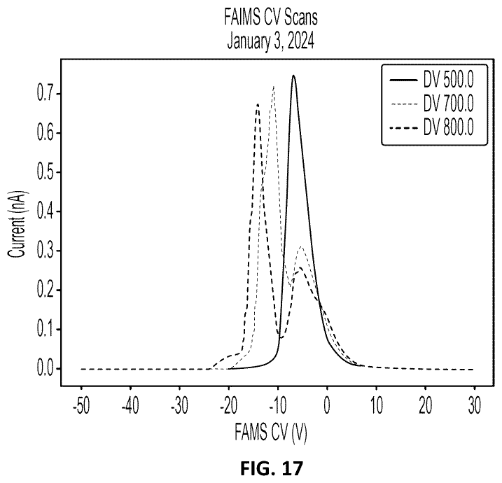

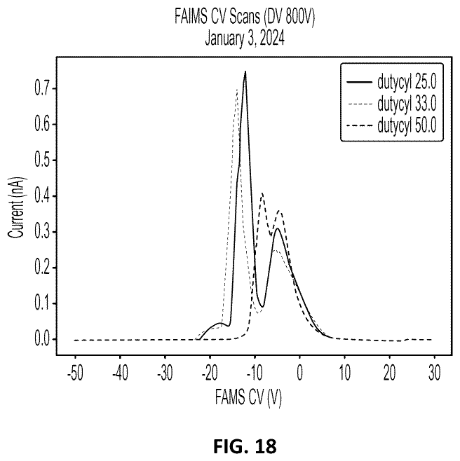

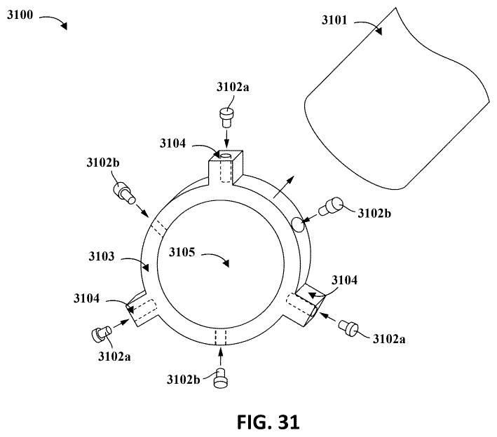

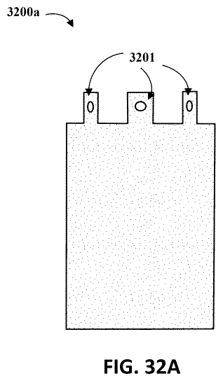

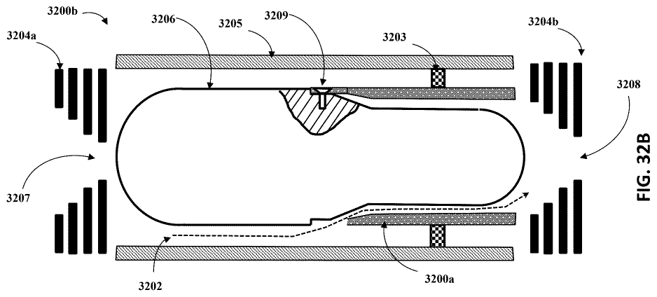

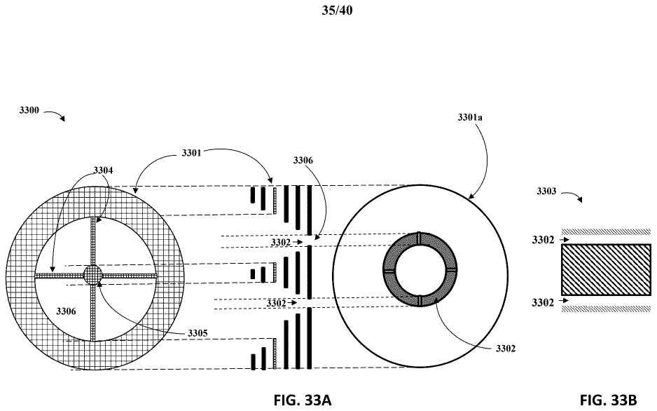

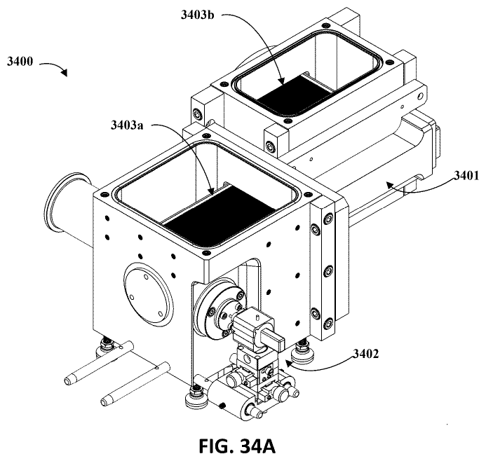

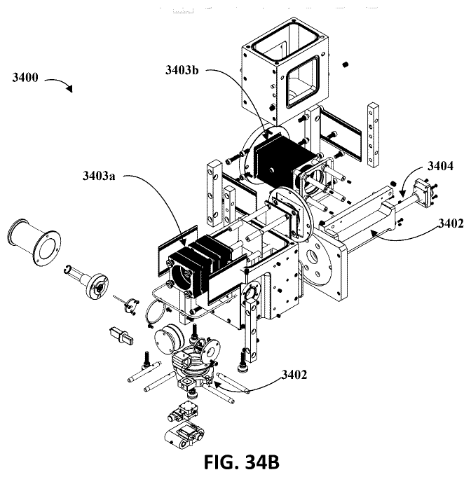

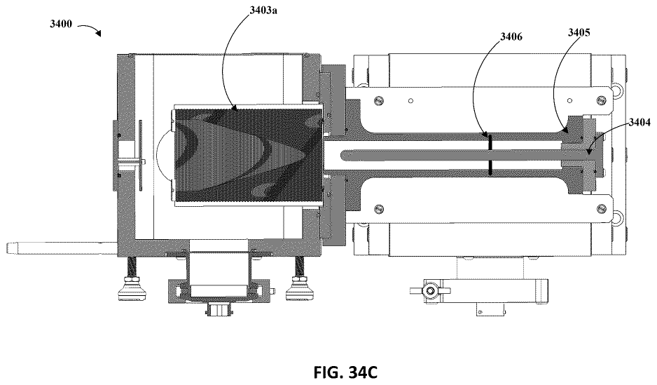

Embodiments of the reduced-pressure field asymmetric ion mobility devices described herein may be configured according to the example geometries illustrated in any of FIGS. 9-14 or FIGS. 25-33.

### Computer Systems

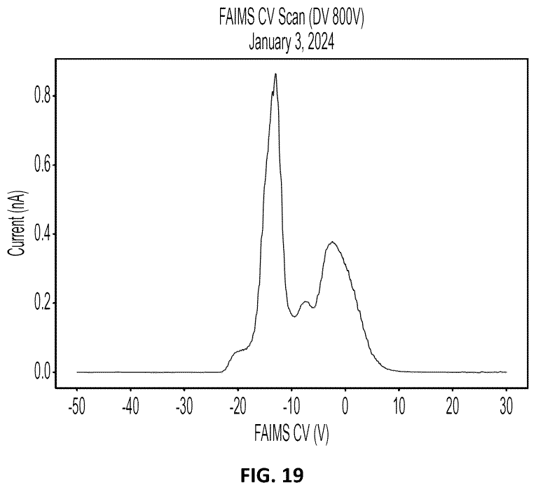

The present disclosure provides computer systems that are programmed to implement methods of the disclosure. FIG. 15 shows a computer system 1501 that is programmed or otherwise configured to implement the methods and systems described herein. The computer system 1501 can be an electronic device of a user or a computer system that is remotely located with respect to the electronic device. The electronic device can be a mobile electronic device.

The computer system 1501 includes a central processing unit (CPU, also “processor” and “computer processor” herein) 1505, which can be a single core or multi core processor, or a plurality of processors for parallel processing. The computer system 1501 also includes memory or memory location 1510 (e.g., random-access memory, read-only memory, flash memory), electronic storage unit 1515 (e.g., hard disk), communication interface 1520 (e.g., network adapter) for communicating with one or more other systems, and peripheral devices 1525, such as cache, other memory, data storage and/or electronic display adapters. The memory 1510, storage unit 1515, interface 1520 and peripheral devices 1525 are in communication with the CPU 1505 through a communication bus (solid lines), such as a motherboard. The storage unit 1515 can be a data storage unit (or data repository) for storing data. The computer system 1501 can be operatively coupled to a computer network (“network”) 1530 with the aid of the communication interface 1520. The network 1530 can be the Internet, an internet and/or extranet, or an intranet and/or extranet that is in communication with the Internet. The network 1530 in some cases is a telecommunication and/or data network. The network 1530 can include one or more computer servers, which can enable distributed computing, such as cloud computing. The network 1530, in some cases with the aid of the computer system 1501, can implement a peer-to −peer network, which may enable devices coupled to the computer system 1501 to behave as a client or a server.

The CPU 1505 can execute a sequence of machine-readable instructions, which can be embodied in a program or software. The instructions may be stored in a memory location, such as the memory 1510. The instructions can be directed to the CPU 1505, which can subsequently program or otherwise configure the CPU 1505 to implement methods of the present disclosure. Examples of operations performed by the CPU 1505 can include fetch, decode, execute, and writeback.

The CPU 1505 can be part of a circuit, such as an integrated circuit. One or more other components of the system 1501 can be included in the circuit. In some cases, the circuit is an application specific integrated circuit (ASIC).

The storage unit 1515 can store files, such as drivers, libraries and saved programs. The storage unit 1515 can store user data, e.g., user preferences and user programs. The computer system 1501 in some cases can include one or more additional data storage units that are external to the computer system 1501, such as located on a remote server that is in communication with the computer system 1501 through an intranet or the Internet.

The computer system 1501 can communicate with one or more remote computer systems through the network 1530. For instance, the computer system 1501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1501 via the network 1530.

Methods as described herein can be implemented by way of machine (e.g., computer processor) executable code stored on an electronic storage location of the computer system 1501, such as, for example, on the memory 1510 or electronic storage unit 1515. The machine executable or machine-readable code can be provided in the form of software. During use, the code can be executed by the processor 1505. In some cases, the code can be retrieved from the storage unit 1515 and stored on the memory 1510 for ready access by the processor 1505. In some situations, the electronic storage unit 1515 can be precluded, and machine-executable instructions are stored on memory 1510.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 1501, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1501 can include or be in communication with an electronic display 1535 that comprises a user interface (UI) 1540 for providing, for example, selection of ion manifold injection parameters. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1505.

### EXAMPLES

The following examples are provided to further illustrate some embodiments of the present disclosure but are not intended to limit the scope of the disclosure; it will be understood by their exemplary nature that other procedures, methodologies, or techniques known to those skilled in the art may alternatively be used.

### Example 1: Separation of Singly Charged Ions From Multiply Charged Ions Using a FAIMS Device Described Herein to Reduce Chemical Noise in a Mass Spectrometry Analysis of a Sample

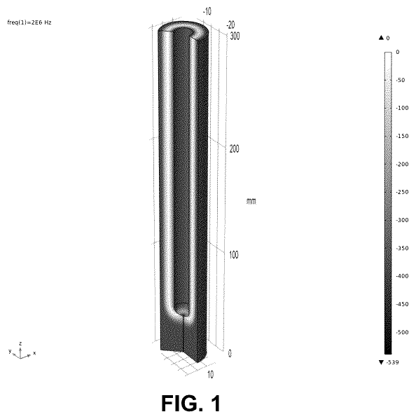

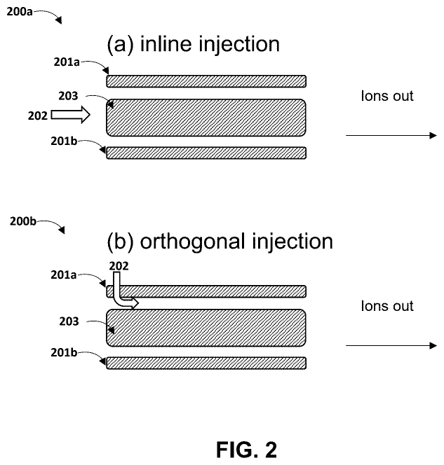

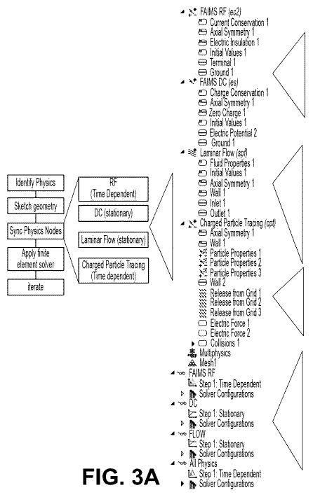

A liquid sample comprising a protein is ionized using a nano-electrospray emitter to produce an ion flux, which is introduced to the ion inlet of a coaxial FAIMS device constructed using a geometry similar to the example device shown in FIGS. 1, 2, or 4-14. The coaxial FAIMS device is purged with nitrogen at a pressure of 4 torr and a square wave form is applied at a frequency, amplitude, and duty cycle analogous to the bi-sinusoidal waveform illustrated in FIG. 2. Multiply charged analyte ions comprising ions of the protein are transmitted with greater than 80% efficiency to the ion outlet of the FAIMS device and are transferred from the ion outlet by a set of ion optics comprising an ion funnel to a Faraday plate. Singly charged ions are removed before the ion outlet, thereby reducing the chemical noise measured (e.g., from ionized solvent) when transmitted to an appropriate the mass analyzer.

### Example 2. Separation of Ion Populations Using a Reduced Pressure Field Asymmetric Ion Mobility System Described Herein

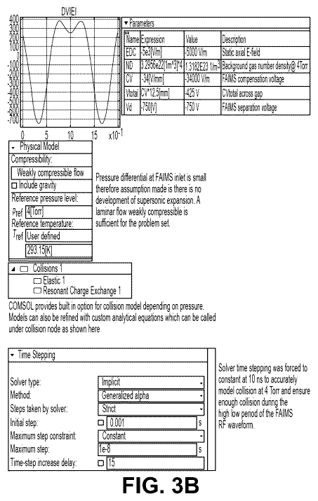

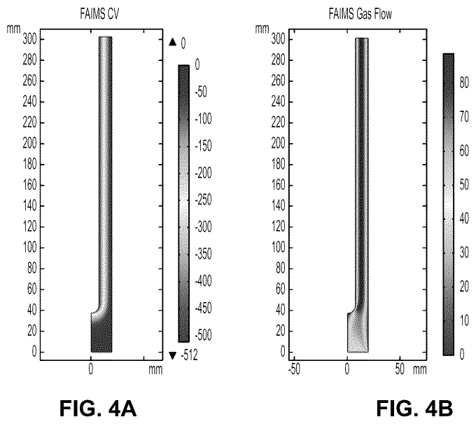

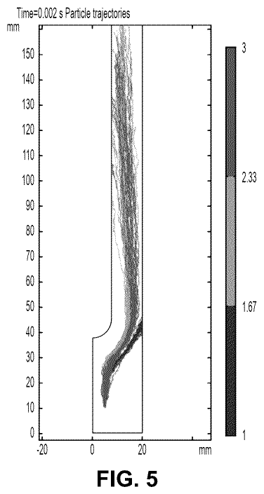

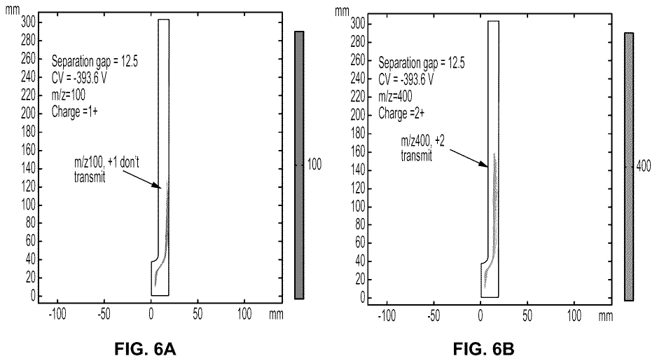

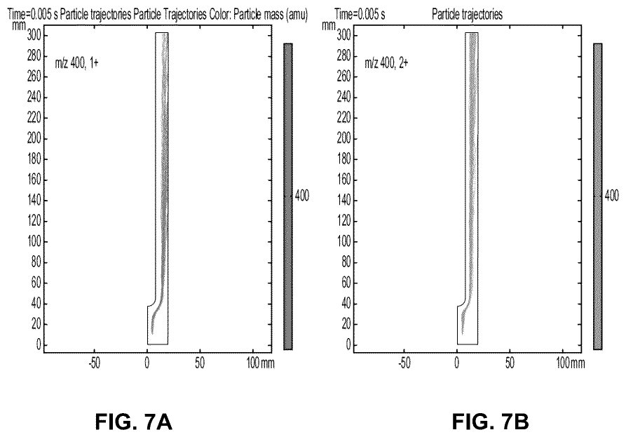

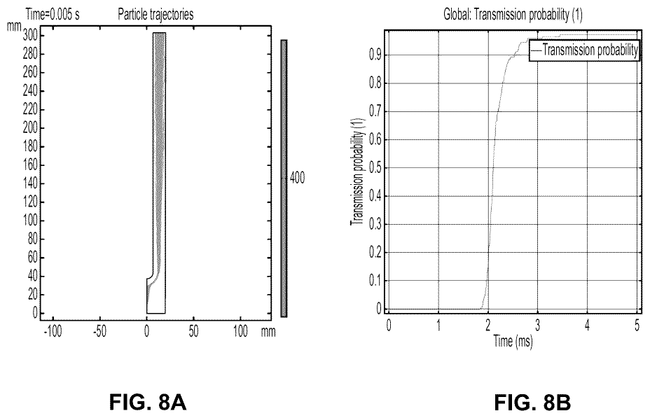

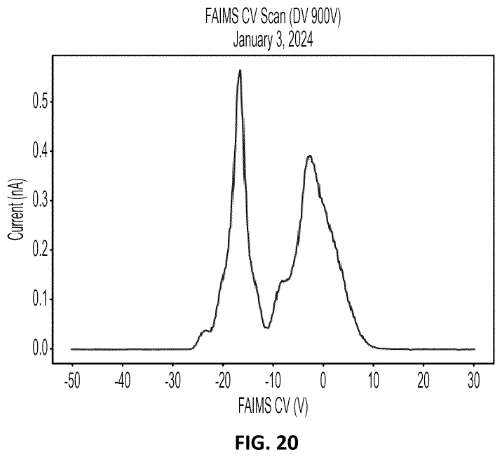

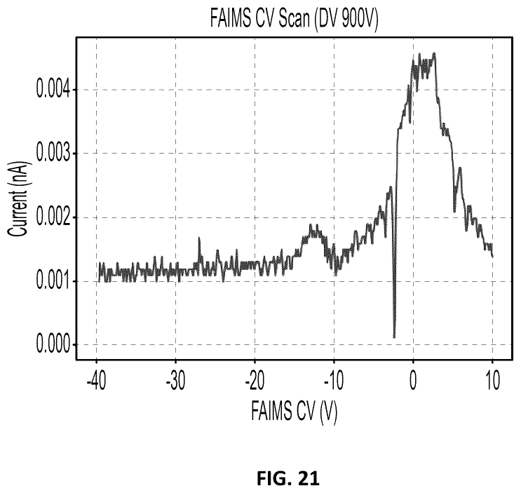

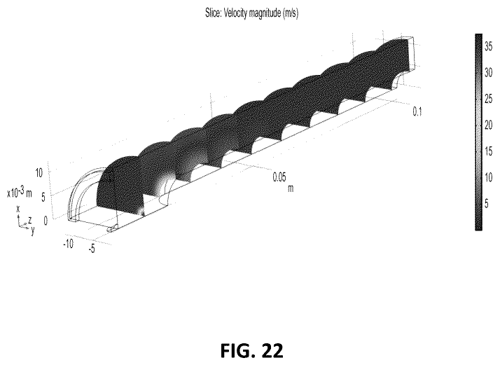

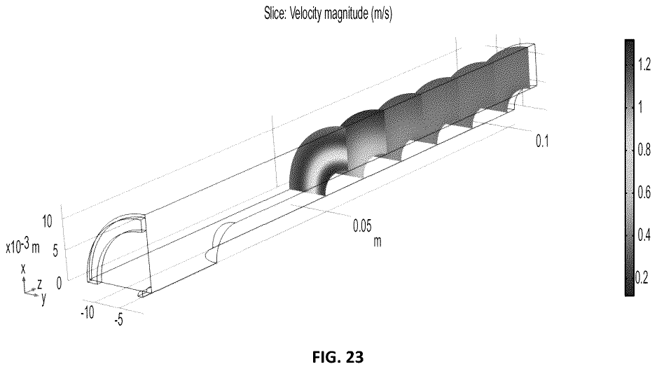

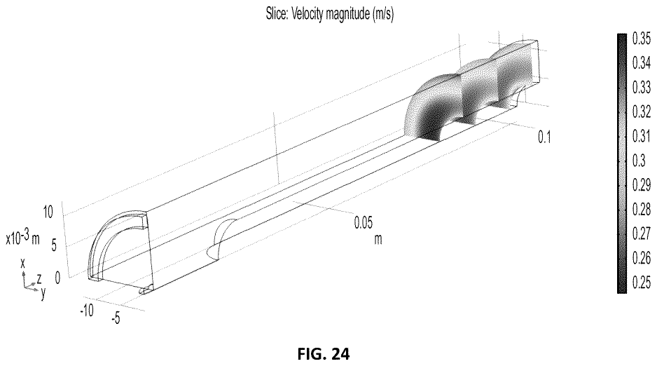

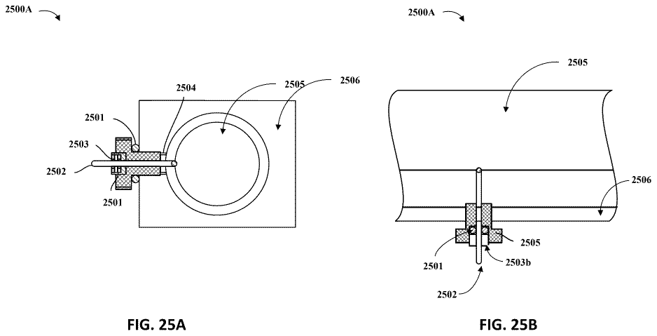

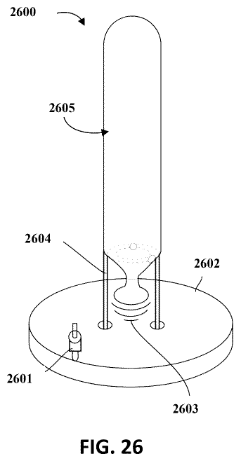

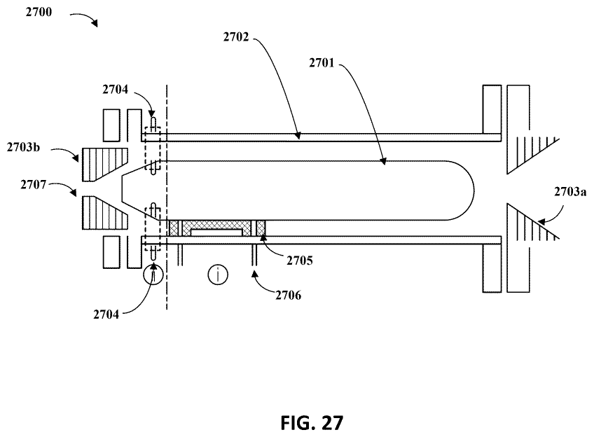

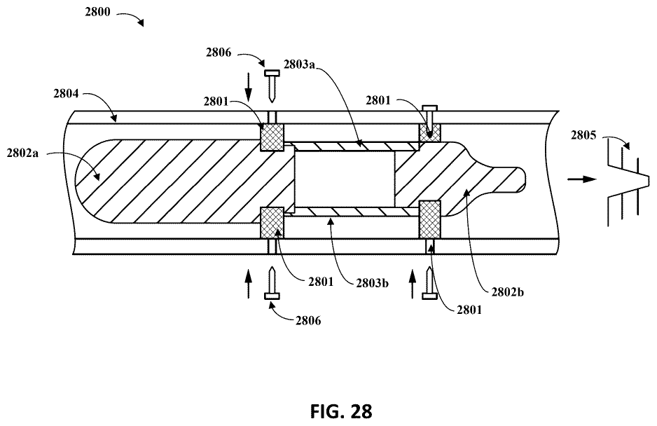

An embodiment of a reduced pressure field asymmetric ion mobility system according to disclosure was constructed based on the schematic diagram shown in FIG. 16. The example implementation shown was used to acquire data presented in FIGS. 17-21 and may be further coupled to a mass spectrometry system. FIG. 17 illustrates experimental data for observed ion current of a test ion (reserpine) at a pressure of 10 Torr in a coaxial field asymmetric ion mobility module according to embodiments provided herein as a function of FAIMS compensation voltage utilizing a rectangular waveform at a fixed duty cycle at three different FAIMS dispersion voltages. FIG. 18 illustrates experimental data measuring ion current of a test ion (reserpine) at a fixed FAIMS dispersion voltage of 800 V as a function of compensation voltage for three different duty cycles (25%, 33%, and 50%) utilizing a rectangular waveform for an example implementation of a coaxial field-asymmetric ion mobility device as described herein. FIG. 19 illustrates experimental data measuring ion current as a function of collected for a peptide mix at a dispersion voltage of 800V for an example implementation of a coaxial field-asymmetric ion mobility device as described herein, showing separation of ions by mobility. FIG. 20 illustrates experimental data measuring ion current as a function of collected for a peptide mix at a dispersion voltage of 900V for an example implementation of a coaxial field-asymmetric ion mobility device as described herein, showing improved resolution of two ion populations by mobility. FIG. 21 illustrates an experimental measurement of a blank for the sample measured in FIGS. 19 and 20. The data shown in each of FIGS. 17-21 demonstrate the capability of reduced pressure field asymmetric ion mobility separation devices described herein to resolve distinct ion populations while maintaining a high overall ion transmission efficiency for analyte ions, consistent with the results predicted by the computational Multiphysics simulations depicted in FIGS. 1, 3-8, and 22-24.

### Example 3: Separation of Ion Populations Using a Reduced Pressure Field Asymmetric Ion Mobility System Described Herein

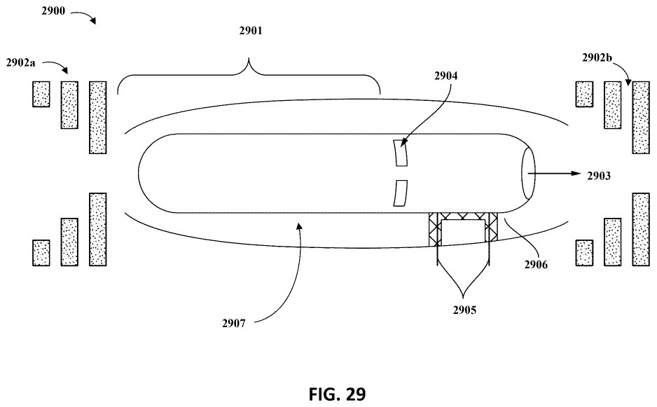

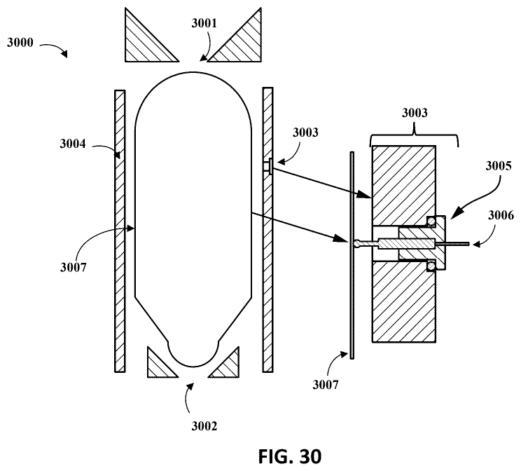

The general procedure of Example 2 is conducted with a device comprising an inner electrode arrangement of any one of FIGS. 25-32.

### Example 4: Separation of Ion Populations Using a Reduced Pressure Field Asymmetric Ion Mobility System Described Herein

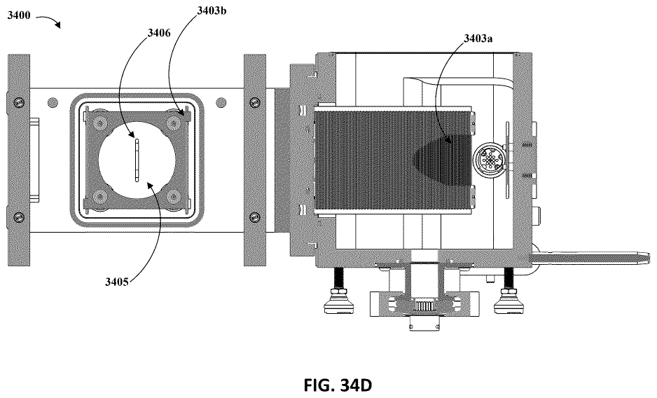

The general procedure of Example 2 is conducted with a FAIMS device further comprising an ion optic as described in FIGS. 33A-33B to deliver ions to the FAIMS device.

### Example 5: Separation of Ion Populations Using a Reduced Pressure Field Asymmetric Ion Mobility System Described Herein

The general procedure of Example 2 is conducted with a FAIMS device having an outer electrode outlet configuration as described in FIGS. 34A-34E.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby. The section headings used herein are for organizational purposes only and are not to be construed as limiting the subject matter described.

1. A reduced-pressure field asymmetric ion mobility device comprising:
an enclosed mobility chamber having an ion inlet and an ion outlet disposed at opposite ends and configured to be filled with an inert gas at a pressure of less than atmospheric pressure;
at least one inner electrode disposed longitudinally between the ion inlet and the ion outlet of the enclosed mobility chamber;
at least one outer electrode disposed longitudinally between the ion inlet and the ion outlet of the enclosed mobility chamber, the outer electrode being disposed such that the inner electrode is at least partially enclosed within the outer electrode; and
one or more power supplies configured deliver a waveform to the inner electrode or the outer electrode, the waveform being configured to differentially deflect ions having different ion mobilities based on interaction of the ions with the waveform and the inert gas, wherein the differential deflection is configured to selectively remove ions having mobilities that correspond to singly charged species prior to said species reaching the ion outlet.

2-7. (canceled)

8. The reduced-pressure field asymmetric ion mobility device of claim 1, wherein the one or more power supplies provide a waveform comprising a sinusoidal waveform, a square waveform, a triangular waveform, a sawtooth waveform, or combinations of one or more thereof.

9. The reduced-pressure field asymmetric ion mobility device of claim 1, wherein the one or more power supplies provide a waveform comprising at least two sinusoids comprising a phase-shift with respect to each other.

10. The reduced-pressure field asymmetric ion mobility device of claim 9, wherein the phase shift is about 30° to about 120° (e.g., about 30°, about 45°, about 60°, about 90°, or about 120°).

11. The reduced-pressure field asymmetric ion mobility device of claim 9, wherein a frequency of at least one of the at least two sinusoids is about 100 kHz to about 2 MHz (e.g., about 100 kHz, about 500 kHz, about 750 kHz, about 1 MHz, about 1.5 MHz, or about 2 MHZ).

12. The reduced-pressure field asymmetric ion mobility device of claim 9, wherein an absolute value of the maximum amplitude of the waveform is about 100 V to about 2000 V (e.g., about 250 V to about 1750 V, about 500 V to about 1500 V, about 750 V to about 1000 V, about 100 V, about 300 V, about 500V, about 700 V, about 1000V, about 1500 V, or about 2000 V).

13. (canceled)

14. The reduced-pressure field asymmetric ion mobility device of claim 1, wherein the waveform is delivered to the inner electrode.

15. The reduced-pressure field asymmetric ion mobility device of claim 1, wherein the waveform is delivered to the outer electrode.

16-18. (canceled)

19. The reduced-pressure field asymmetric ion mobility device of claim 1, wherein the ion outlet extends at angle to a direction of ion movement between the inner electrode and the outer electrode, wherein the angle is about 60° to about 120° (e.g., about 70° to about 110°, about 80° to about 90°).

20. The reduced-pressure field asymmetric ion mobility device of claim 1, wherein the ion inlet and the ion outlet are substantially aligned along a common axis.

21-33. (canceled)

34. The reduced-pressure field asymmetric ion mobility device of the preceding claims, wherein the reduced-pressure field asymmetric ion mobility device is configured for transmission of ions having m/z values of about 400 to about 900.

35. The reduced-pressure field asymmetric ion mobility device of claim 1, wherein the reduced-pressure field asymmetric ion mobility device is configured to remove at least about 80% of singly charged ions within the first 50% of the distance between the inlet and the outlet.

36. The reduced-pressure field asymmetric ion mobility device of claim 1, wherein the reduced-pressure field asymmetric ion mobility device is configured to resolve singly charged ions from multiply charged ions in a radial direction about the central axis of the enclosed mobility chamber.

37. The reduced-pressure field asymmetric ion mobility device of claim 36, wherein the radial resolution of multiply charged species from singly charged species is at least about 2 mm on average (e.g., at least 2 mm, at least 5 mm, at least 10 mm, at least 12 mm, or at least 20 mm) when measured at the ion outlet.

38. The reduced-pressure field asymmetric ion mobility device of claim 1, wherein the reduced-pressure field asymmetric ion mobility device further comprises one or more sets of ion optics configured to guide ions into the ion inlet, out of the ion outlet, or a combination thereof.

39-41. (canceled)

42. The reduced-pressure field asymmetric ion mobility device of claim 1, wherein an average ion transmission efficiency of multiply charged ions from the ion inlet to the ion outlet is at least about 50% (e.g., at least about 50%, at least about 70%, at least about 80%, at least about 90%, or at least about 95%).

43. The reduced-pressure field asymmetric ion mobility device of claim 1, wherein an average ion transmission efficiency of singly-charged ions from the ion inlet to the ion outlet is no more than about 50%, (e.g., no more than about 50%, no more than about 30%, no more than about 10%, no more than about 5%, or no more than about 1%).

44. The reduced-pressure field asymmetric ion mobility device of claim 1, wherein multiply charged ions are transmitted from the ion inlet to the ion outlet in less than about 100 milliseconds.

45-46. (canceled)

47. The reduced-pressure field asymmetric ion mobility device of claim 1, wherein the differential deflection is configured to selectively remove ions having mobilities that correspond to singly charged species have a mass of about 400 Da or less (e.g., about 300 Da or less, about 200 Da or less, or about 100 Da or less).

48. The reduced-pressure field asymmetric ion mobility device of claim 47, wherein about 5%-50%, about 10%-40%, or about 20%-35% of the ions are selectively removed by the ion mobility device.

49-88. (canceled)
